(19) United States
(12) Patent Application Publication
(10) Pub. No.: US 2026/0320223 A1
(43) Pub. Date: Oct. 15, 2026

(54) SECURE AND EFFICIENT WORKFLOWS USING TRUSTED EXECUTION ENVIRONMENTS

(71) Applicant: Google LLC, Mountain View, CA (US)

(72) Inventors: Michael Feng, San Mateo, CA (US); Shruti Murali, Sunnyvale, CA (US); Jacob Mark Hallberg, Sunnyvale, CA (US); Akhil Dhavala, Palo Alto, CA (US); Ouyang Zhang, Mountain View, CA (US)

(21) Appl. No.: 18/860,989

(22) PCT Filed: Dec. 19, 2023
(86) PCT No.: PCT/US2023/084830

§ 371 Date: Oct. 28, 2024

(51) Int. Cl. G06F 21/62; G06F 21/60

(52) U.S. Cl. CPC G06F 21/6245; G06F 21/602

(57) ABSTRACT

Methods, systems, and apparatus, including medium-encoded computer program products for selecting and displaying content in privacy preserving manners. In one aspect, a method includes receiving, by a first trusted content platform and from a client device of a user, a first digital component request that includes sensitive data and non-sensitive data. The first trusted content platform sends a second digital component request that includes encrypted user data to one or more second trusted content platforms. The first trusted content platform receives, from each second trusted content platform, one or more first candidate digital components. The first trusted content platform sends a third digital component request to each of one or more second untrusted content platforms. The first trusted content platform receives, from each second untrusted content platform, one or more second candidate digital components. The first trusted content platform selects a given digital component.

### TECHNICAL FIELD

This specification relates to data security, data privacy, and efficiently performing computing tasks using trusted execution environments.

### BACKGROUND

A trusted execution environment (TEE) provides a secure environment for computation and is sometimes implemented as a secure area of a main processor. A TEE can guarantee that code and data loaded inside the TEE are protected with respect to integrity and confidentiality. Integrity indicates that unauthorized entities cannot alter code and/or data within the TEE, and confidentiality indicates that unauthorized entities cannot read code and/or data within the TEE.

### SUMMARY

This specification describes technologies that increase the speed and efficiency at which computing tasks are performed by distributing tasks among different types of execution environments including TEEs. In general, executing tasks in a TEE is more resource intensive than executing the same tasks in a general-purpose environment, e.g., by a computer's main operating system. For example, applications that run in a TEE can be separated from other applications and resources of the computer using cryptographic functions and other functions that can require significant computations that introduce additional latency to execution of the applications. However, a TEE provides enhanced security of sensitive data, such as user data for which the security is critical.

The techniques described in this specification leverage one or more TEEs and general purpose computing environments (e.g., server class computers) to efficiently and quickly select and distribute relevant content to users based on sensitive user data without compromising user privacy or data security. To select relevant content while enhancing user privacy, sensitive user data may only be stored in TEEs when stored away from the user's device in cleartext, and it is not released to or accessible in cleartext to untrusted platforms such as untrusted content platforms and digital component providers. Storing and evaluating user data only in TEEs, e.g., TEEs of trusted content platforms, when off of the user's device ensures user privacy while also enabling delivery of content relevant to a user.

Delivering relevant content can reduce the demand on computing resources. For example, since users need not load additional content when the relevant content satisfies their needs, fewer packets will traverse the network, servers process fewer requests (saving both processing and power), and client devices issue fewer requests (saving processing and power). Such savings are additionally beneficial when the client device is a mobile device, which can be connected to bandwidth-constrained cellular networks (increasing the importance of bandwidth savings) and run on battery (increasing the importance of reducing additional requests and associated power usage).

However, as discussed above, executing computing tasks in TEEs is resource intensive and adds latency to the process. For example, the cryptography used to protect data can involve substantial computing resources to process. Therefore, implementing all techniques using only TEEs can be undesirable, especially in content distribution workflows in which content has to be selected and sent to client devices in milliseconds or errors (e.g., page load errors) may occur.

When latency causes such delays in providing digital components, undesirable behavior at a client device can result. For example, a delay responding to a request can result in page load errors at the client device or cause portions of an electronic document, e.g., web page, or other resource to remain unpopulated even after other portions of the electronic document are presented at the client device. Also, as the delay in providing the digital component to the client device increases, it is more likely that the electronic document will no longer be presented at the client device when the digital component is delivered to the client device, thereby negatively impacting a user's experience with the electronic document. Further, delays in providing the digital component can result in a failed delivery of the digital component, for example, if the electronic document is no longer presented at the client device when the digital component is provided.

Using the techniques described in the specification, untrusted content platforms, which can operate using substantially less computing resources, can perform operations that do not risk compromising user privacy or the security of other confidential information or code. For example, untrusted platforms can collect candidate digital components using only non-sensitive data (e.g., no user data) and provide those candidate digital components to one or more trusted content platforms, and the trusted content platforms can determine the relevance of the component to the user and/or generate data that is used to select a digital component from multiple candidate digital components. The trusted content platforms can include a TEE in which user data is processed in cleartext to ensure that such data is not exposed outside the TEE. This approach enables accurate selection of relevant content using sensitive data and effectively limits the use of computationally intensive resources to operations that involve sensitive data, resulting in fast and efficient content selection and distribution while also enhancing user privacy and data security.

Compared to existing techniques, the techniques described in this document enable faster and more efficient content selection while securely protecting sensitive user data. Today, there are different solutions such as end-to-end encryption that protects user data. However, even encryption-based solutions lack security for user data. For example, without the use of TEEs, the computers that decrypt the user data and process the decrypted user data can use the user data maliciously and/or provide such that to other entities for such use. One solution to encryption-based solutions would be to use only TEEs to perform all of the operations of the content selection process. However, TEEs require significantly more computational resources and significantly more time to process data than other types of computing environments that involve less security. The techniques described in this document utilize both trusted content platforms that include TEEs and non-trusted content platforms that are generally secure but do not include TEEs to process sensitive and non-sensitive data using different routes/workflows to enable faster and more efficient content selection while securely protecting sensitive user data. In particular, sensitive data is transferred along a fully trusted route and processed by TEEs while non-sensitive data is transferred along a different, non-fully trusted, route so that the non-sensitive data is processed in a less computationally intensive computing environment than the sensitive data and without consuming the resources of TEEs. This ensures that the sensitive data is fully protected reducing the computing resource consumption and content delivery speed relative to implementations that include all TEEs. For example, using these two different routes/workflows, sensitive data is still protected even if the less secure route is breached or hacked. Such a hybrid approach is an optimal compromise to process securely only part of the user data (the sensitive data), with some latency that is accepted for selecting content based on such data, as the focus is on the data protection. As for the non-sensitive data, the burden on resources handling is reduced with the absence of TEEs and encryption, so that content selected based on such data can be provided fast.

In general, one innovative aspect of the subject matter described in this specification can be embodied in methods including the operations of receiving, by a first trusted content platform and from a client device of a user, a first digital component request including (i) sensitive data including encrypted user data for the user and (ii) non-sensitive data including contextual data related to a resource with which a selected digital component will be presented at the client device; sending, by the first trusted content platform, a second digital component request including the encrypted user data to one or more second trusted content platforms; receiving, by the first trusted content platform and from each second trusted content platform, one or more first candidate digital components; sending, by the first trusted content platform, a third digital component request to each of one or more second untrusted content platforms, wherein the third digital component request sent to each second untrusted content platform include the contextual data; receiving, by the first trusted content platform and from each second untrusted content platform, one or more second candidate digital components; selecting, by the first trusted content platform, a given digital component from a set of candidate digital components including the one or more first candidate digital components received from each second trusted content platform and the one or more second candidate digital components received from each second untrusted content platform; and sending the given digital component to the client device of the user for presentation with the resource. Other implementations of this aspect include corresponding apparatus, systems, and computer programs, configured to perform the aspects of the methods, encoded on computer storage devices.

These and other implementations can each optionally include one or more of the following features. In some aspects, the second digital component request includes first-party data related user actions of a user of the client device with respect to one or more resources of a publisher of the resource.

In some aspects, at least part of the first trusted content platform or at least a part of the one or more second trusted content platforms is implemented on the client device.

In some aspects, the one or more first candidate digital components are selected from one or more second trusted repositories of digital components. Each of the one or more second trusted repositories is maintained by a corresponding second trusted content platform.

In some aspects, the one or more second candidate digital components are selected from one or more second untrusted repositories of digital components. Each of the one or more second untrusted repositories is maintained by a corresponding second untrusted content platform.

In some aspects, each second trusted content platform is configured to send the non-sensitive data to a corresponding second untrusted content platform operated by a same entity that operates the second trusted content platform.

In some aspects, the corresponding second untrusted content platform is configured to select one or more candidate digital components based on the non-sensitive data. The corresponding second untrusted content platform is configured to send the selected one or more candidate digital components to the second trusted content platform.

In some aspects, each second trusted content platform is configured to decrypt the encrypted user data and to generate a selection value for each of a set of candidate digital components comprising the first candidate digital components and the selected one or more candidate digital components based on the decrypted user data. The second trusted content platform selects the given digital component from the set of candidate digital components based on the generated selection value for each candidate digital component.

In some aspects, each second trusted content platform is configured to decrypt the encrypted user data, generate, based at least on the decrypted user data, a score for each candidate digital component in the set of candidate digital components based on a selection value for the candidate digital component and a predicted performance metric for the candidate digital component, and select the given candidate digital component based on the score for each candidate digital component.

In some aspects, selecting, by the first trusted content platform, a given digital component from a set of candidate digital components includes receiving, from each second trusted content platform and each of the one or more second untrusted content platform, a selection value for each candidate digital component and selecting the given digital component based on the selection values.

In general, another innovative aspect of the subject matter described in this specification can be embodied in methods including the operations of receiving, by a first untrusted content platform and from a client device of a user, a first digital component request including (i) sensitive data including encrypted user data for the user and (ii) non-sensitive data including contextual data related to a resource with which a selected digital component will be presented at the client device; sending, by the first untrusted content platform, a second digital component request including the sensitive data to one or more first trusted content platforms; receiving, by the first untrusted content platform and from each second trusted content platform, one or more encrypted trusted candidate digital components; sending, by the first untrusted content platform, a third digital component request to one or more second untrusted content platforms, wherein the third digital component request sent to each second untrusted content platform includes the non-sensitive data; receiving, by the first untrusted content platform and from each second untrusted content platform, one or more untrusted candidate digital components; and sending one or more of the encrypted trusted candidate digital components and the candidate digital components to the client device of the user for presentation with the resource. Other implementations of this aspect include corresponding apparatus, systems, and computer programs, configured to perform the aspects of the methods, encoded on computer storage devices.

These and other implementations can each optionally include one or more of the following features. In some aspects, the first trusted content platform is configured to send the encrypted user data to one or more second trusted content platforms, and receive one or more trusted candidate digital components from each of the second trusted content platforms.

In some aspects, at least one of the one or more second trusted content platforms is configured to send first-party data to a corresponding second untrusted content platform.

In some aspects, the corresponding second untrusted content platform is configured to select candidate digital components based on the first-party data. The corresponding second untrusted content platform is configured to send the selected candidate digital components to the second trusted content platform.

In some aspects, the second trusted content platform is configured to select one or more of the selected candidate digital components to send to the first trusted content platform as trusted candidate digital components based on the encrypted user data.

In some aspects, the first trusted content platform is configured to select one or more of the trusted candidate digital components received from the second trusted content platforms to send as encrypted trusted candidate digital components to the first untrusted content platform.

In general, another innovative aspect of the subject matter described in this specification can be embodied in methods including the operations of sending, by a client device of a user, a first digital component request to one or more first untrusted content platforms, the first digital component request including non-sensitive data including contextual data related to a resource with which a selected digital component will be presented at the client device; receiving, by the client device, one or more untrusted candidate digital components from the one or more first untrusted content platforms; sending, by the client device, a second digital component request to one or more first trusted content platforms, the second digital component request including user data; receiving, by the client device, one or more trusted candidate digital components from the one or more first trusted content platforms; and selecting, by the client device, a given digital component from a set of candidate digital components comprising the one or more untrusted candidate digital components received from each first untrusted content platform and the one or more encrypted trusted candidate digital components received from each first trusted content platform for presentation with the resource. Other implementations of this aspect include corresponding apparatus, systems, and computer programs, configured to perform the aspects of the methods, encoded on computer storage devices.

These and other implementations can each optionally include one or more of the following features. In some aspects, the first trusted content platform is configured to send a fourth digital component request including encrypted user data to one or more second trusted content platforms, and receive one or more trusted candidate digital components from each of the second trusted content platforms.

In some aspects, at least one of the one or more second trusted content platforms is configured to send a fifth digital component request including the non-sensitive data and first-party data related user actions of a user of the client device with respect to one or more resources of a publisher of the resource.

In some aspects, the corresponding second untrusted content platform is configured to select candidate digital components based on the non-sensitive data and the first-party data. The corresponding second untrusted content platform is configured to send the selected candidate digital components to the second trusted content platform.

In some aspects, the second trusted content platform is configured to select one or more of the selected candidate digital components to send to the first trusted content platform as trusted candidate digital components based on the encrypted user data.

In some aspects, the first trusted content platform is configured to select one or more of the trusted candidate digital components received from the second trusted content platforms to send as encrypted trusted candidate digital components to the client device.

In some aspects, the first trusted content platform is configured to send, to each of the second trusted content platforms, the encrypted user data and the non-sensitive data for the second trusted content platform.

In some aspects, selecting, by the client device, a given digital component from a set of candidate digital components includes receiving, from each first untrusted content platform and each first trusted content platform, a selection value for each of the candidate digital components in the set of candidate digital components and selecting the given digital component based on the selection values.

In some aspects, selecting, by the client device, a given digital component from a set of candidate digital components includes determining, for each candidate digital component in the set of candidate digital components, a score based on a selection value for the candidate digital component and a predicted performance metric for the candidate digital component and selecting the given digital component based on the score for each candidate digital component.

As background, historically, third-party cookies (e.g., cookies from a different domain than the resource being rendered by a client device) have been used to identify data collected from client devices across the Internet. However, some browsers and device platforms block the use of third-party cookies and third-party cookies are increasingly being removed from use, thereby preventing the collection and identification of data using third-party cookies. This creates a challenge when attempting to utilize collected data to make inferences, segment data, or otherwise utilize data to enhance online browsing experiences, e.g., by selecting content relevant to users based on the data collected and identified using third-party cookies. In other words, without the use of third-party cookies, much of the data previously collected is no longer available, which prevents computing systems from being able to use that data to group users based on shared user attributes or activities performed by the users at particular web pages or other resources, to enhance the online experience for users, and/or to display relevant content to users.

Particular embodiments of the subject matter described in this specification can be implemented to solve challenges that arise from the eradication of third-party cookies.

Using the techniques described in this specification, relevant digital components can be delivered to a user's device without compromising user privacy while also increasing the speed and efficiency with which the digital components are distributed. Data that are potentially sensitive are stored and accessible in cleartext only on trusted content platforms (or the user's device), where such data are unavailable to untrusted content platforms, thereby protecting privacy. Since the data are present on TEEs of trusted content platforms, the data are available to determine content relevant to a user, a user's request, a client device, and so on, while still preserving user privacy by preventing dissemination of sensitive data.

In addition, particular embodiments of the subject matter described in this specification can be implemented to address challenges that arise from the computing resources required to operate trusted computing platforms. For example, trusted computing platforms often use compute-intensive cryptographic techniques, which can require substantial processor and power resources. By assigning operations that do not compromise user privacy to untrusted content platforms, the techniques of this specification both reduce the processor resources required and reduce the amount of energy demanded and consumed by such resources. Thus, the techniques described in this document can distribute the operations of a process to select and distribute digital components between trusted platforms that include TEEs for processing sensitive data and untrusted platforms (e.g., general purpose servers) in ways that reduce latency and resource consumption while enhancing user privacy and data security.

The details of one or more embodiments of the subject matter described in this specification are set forth in the accompanying drawings and the description below. Other features, aspects, and advantages of the invention will become apparent from the description, the drawings, and the claims.

### BRIEF DESCRIPTION OF THE DRAWINGS

FIG. 1 is a block diagram of an example environment in which digital components are selected and distributed to client devices in a privacy preserving manner.

FIG. 2A is a flow diagram of an example process for privacy-preserving content selection.

FIG. 2B is a flow diagram of an example process for obtaining digital components.

FIG. 3 is a block diagram of another example environment in which digital components are selected and distributed to client devices in a privacy preserving manner.

FIG. 4 is flow diagram of another example process for privacy-preserving content selection.

FIG. 5 is a block diagram of another example environment in which digital components are selected and distributed to client devices in a privacy preserving manner.

FIG. 6A is a flow diagram of another example process for privacy-preserving content selection.

FIG. 6B is a flow diagram of an example process for obtaining digital components.

FIG. 7 is a block diagram of an example computer system.

Like reference numbers and designations in the various drawings indicate like elements.

### DETAILED DESCRIPTION

In general, this document describes systems and techniques for selecting digital components for display at client devices in ways that are both resource efficient and that protect user privacy by determining relevant content without providing user data to untrusted content platforms and/or to unaffiliated web sites. Ensuring the privacy of user data, e.g., personal data of a user, is a requirement of many computing systems, especially those connected to public networks such as the Internet. Some users who do not trust that strong privacy protection will be enforced by a system will simply choose not to use that system.

However, while it is important to protect user privacy, it remains beneficial to display to a user content relevant to or of interest of the user. The techniques described in this document use trusted computing platforms to determine relevant content without compromising user privacy, and without enabling untrusted content platforms, digital component providers, or other entities to track the user's activity across multiple web sites or other resources. Thus, the techniques both deliver relevant content and protect user privacy fast and efficiently, as described further below.

In addition, delivering relevant content also improves resource efficiency, including reducing the use of power by client devices, servers and network devices (e.g., routers and switches). When relevant content is delivered, client devices issue fewer requests, less data (requests and responses) flow across a network (preserving bandwidth and reducing power use by routers and switches), and servers process fewer requests. Since request volume across the Internet is staggeringly large, the aggregate savings across requests can be substantial.

The techniques of this specification encourage delivery of relevant content by obtaining candidate content from multiple content providers, and selecting the content expected to be most relevant. The specification describes techniques that can be used to obtain both untrusted digital components and trusted digital components as candidates for display at a client device of a user. As used herein, an untrusted digital component is a digital component that is selected based on non-sensitive data (e.g., contextual data) and a trusted digital component is a digital component that is selected based on sensitive data, e.g., user attributes (e.g., general location, age, etc.). Sensitive data is data that is considered to be sensitive and can vary based on the privacy level of the system. However, data that is considered to be sensitive is processed differently than non-sensitive data. Importantly, the user data that is employed to evaluate the constraints associated with a trusted digital component never leave trusted platforms in unencrypted form, thereby preserving user privacy. By considering both types of digital components in different environments, the techniques increase the likelihood that relevant content is displayed while also efficiently using computing resources and reducing the latency in delivering the content to the user.

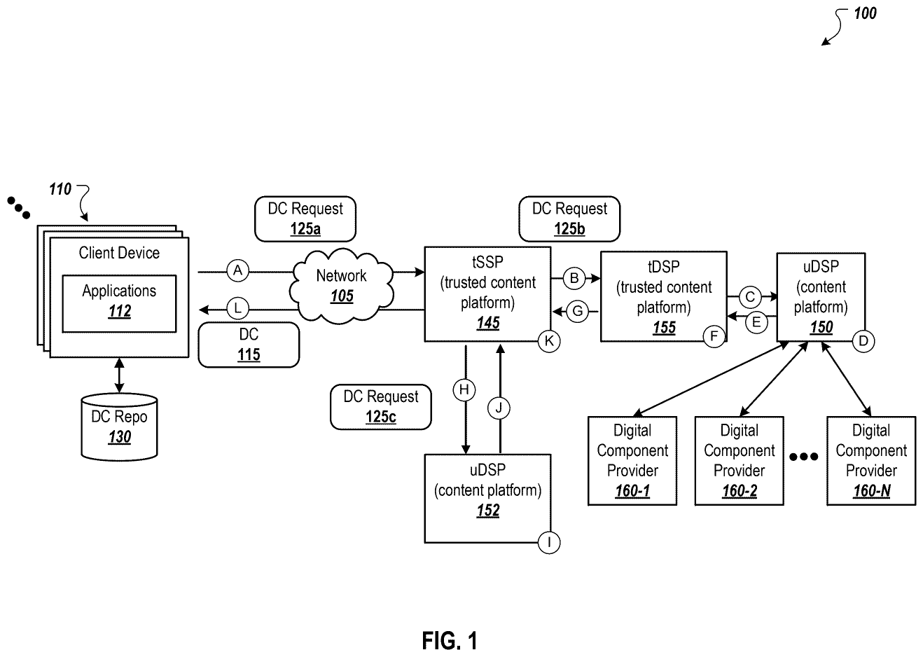

FIG. 1 is a block diagram of an example environment 100 in which digital components 115 are selected for client devices 110 in a privacy preserving manner. The environment 100 includes a data communication network 105, e.g., a local area network (LAN), a wide area network (WAN), the Internet, a mobile network, or a combination thereof. The data communication network 105 connects client devices 110 to content platforms, which can include supply side platforms (SSPs), e.g., SSP 145, and/or demand side platforms (DSPs) 150, 152, 155.

Each content platform 145, 150, 152, 155 can be a trusted content platform 145, 155 or an untrusted content platform 150, 152. For example, although FIG. 1 includes only a trusted SSP (tSSP 145), an SSP can be an untrusted SSP (uSSP) or a trusted SSP (tSSP) 145. A DSP 150, 152, 155 can be an untrusted DSP (uDSP) 150, 152 or a trusted DSP (tDSP) 155.

The tSSP 145 is also referred to as a first trusted content platform. The tDSP 155 is also referred to as a second trusted content platform. The uDSP 150 is also referred to as a second untrusted platform.

An SSP 145 is a technology platform implemented in hardware and/or software that automates the process of obtaining digital components 115 for presentation with resources of publishers. Publishers of resources can use an SSP 140 to manage the process of obtaining digital components 115 for digital component slots of its resources. Each publisher can have a corresponding SSP 145 or multiple SSPs 145. Some publishers may share the same SSP 145.

A DSP 150, 152, 155 is a technology platform implemented in hardware and/or software that automates the process of distributing digital components 115 for display with the resources. A DSP 150, 152, 155 can interact with multiple SSPs 145 on behalf of digital component providers 160 to provide digital components 115 for display with the resources of multiple different publishers. Digital component providers 160 can create (or otherwise publish) digital components 115 that are displayed with publisher's resources, e.g., in digital component slots of publisher's resources.

A trusted content platform (tCP), e.g., tSSP 145 and tDSP 155, includes or is implemented using an environment for executing code on a computing platform in which the environment ensures that the code is isolated from the computing platform, providing confidentiality of the code. The computing platform can provide the tCP using hardware, software or a combination of hardware and software. For example, each tCP can include a TEE in which computing tasks performed by the tCP are performed. In some implementations, a tCP includes a hardware isolation mechanism that runs a secure operating system, and the secure operating system runs applications, thus providing isolation for the applications. Third parties can inspect the operating system code, allowing such parties to confirm the isolation properties. Thus, use of tCP ensures that data stored on the tCP cannot be accessed by outside entities, thereby protecting user privacy. For example, a TCP can use cryptographic techniques to ensure that access to data and to code is limited to authorized parties.

An untrusted platform, such as uSSP and uDSP 150, 152, does not provide similar trust guarantees. For example, a server that executes tasks using a conventional operating system can be considered an untrusted platform. However, while untrusted platforms do not provide the same isolation guarantees, they can be quite secure, including using anti-virus, firewalls, process isolation and other security features.

In some implementations, uDSP 150 and tDSP 155 are operated by, or on behalf of, a first entity, and tSSP 145 is operated by, or on behalf of, a second entity. That is, one entity (e.g., an SSP service provider) provides the trusted SSP functionality, and one entity (e.g., a DSP server provider) provides both trusted and untrusted DSP functionality. In another example, the functionality of the SSP can be provided for one entity (e.g., an SSP service provider) using the tSSP 145 and the functionality of the DSP can be provided for a different entity (e.g., the DSP service provider) using the tDSP 155.

In this way, a DSP can select candidate digital components to provide in response to a request in two different environments and using two different types of data, sensitive and non-sensitive data. This is in contrast to digital component distributions systems in which all of the functionality of an SSP of an entity is implemented on a single computer or multiple instances of the same computing environment and in which all of the functionality of a DSP of an entity is implemented on a single computer or multiple instances of the same computing environment.

Further, to simplify the diagram, FIG. 1 shows requests flowing from a single tSSP 145 to a single tDSP 155, but tSSP 145 can send requests to any number of tDSPs. In addition, tSSP 1445 can send requests to multiple uDSPs 152 that are each operated by different entities, e.g., different entities that provide candidate digital components for display to users on behalf of digital component providers 160. That is, each uDSP 152 can be operated by or on behalf of a different entity (e.g., a different DSP service provider) than the tDSP 155 and the tDSP 150.

The network 105 can also connect the various content platforms 145, 150, 152, 155 to one another and/or to digital component providers 160, e.g., to servers of the digital component providers 160. Thus, content platforms 145, 150, 152, 155 can distribute digital components of multiple digital component providers 160 to client devices 110. Further, while the digital component providers 160 are illustrated as outside the content platforms 145, 150, 152, 155, a content platform 145, 150, 152, 155 can both contain digital component providers 160 and communicate with digital component providers 160 via the network 105 that are outside the content platforms 145, 150, 152, 155.

In some implementations, at least part of the tSSP 145 and the tDSP 155 can be implemented on the client device 110. For example, at least some of the operations of the tSSP 145 and the tDSP 155 can be performed by the client device 110. The other operations of the tSSP 145 and the tDSP 155 can be performed by a server of the tSSP 145 or a server of the tDSP 155. In some implementations, all of the functionality of the tSSP 145 is implemented on the client device 110 and/or all of the functionality of the tDSP 155 is implemented on the client device 110.

A client device 110 is an electronic device capable of requesting and receiving online resources over the network 105. Example client devices 110 include personal computers, gaming devices, mobile communication devices, digital assistant devices, augmented reality devices, virtual reality devices, and other devices that can send and receive data over the network 105. A client device 110 typically includes a user application, such as a web browser, to facilitate the sending and receiving of data over the network 105, but native applications (other than browsers) executed by the client device 110 can also facilitate the sending and receiving of data over the network 105.

A gaming device is a device that enables a user to engage in gaming applications, for example, in which the user has control over one or more characters, avatars, or other rendered content presented in the gaming application. A gaming device typically includes a computer processor, a memory device, and a controller interface (either physical or visually rendered) that enables user control over content rendered by the gaming application. The gaming device can store and execute the gaming application locally, or execute a gaming application that is at least partly stored and/or served by a cloud server (e.g., online gaming applications). Similarly, the gaming device can interface with a gaming server that executes the gaming application and “streams” the gaming application to the gaming device. The gaming device may be a tablet device, mobile telecommunications device, a computer, or another device that performs other functions beyond executing the gaming application.

Digital assistant devices include devices that include a microphone and a speaker. Digital assistant devices are generally capable of receiving input by way of voice, and respond with content using audible feedback, and can present other audible information. In some situations, digital assistant devices also include a visual display or are in communication with a visual display (e.g., by way of a wireless or wired connection). Feedback or other information can also be provided visually when a visual display is present. In some situations, digital assistant devices can also control other devices, such as lights, locks, cameras, climate control devices, alarm systems, and other devices that are registered with the digital assistant device.

A client device 110 can include applications 112, such as web browsers and/or native applications, to facilitate the sending and receiving of data over the network 105. A native application is an application developed for a particular platform or a particular device (e.g., mobile devices having a particular operating system). Although operations may be described as being performed by the client device 110, such operations may be performed by an application 112 running on the client device 110 and/or by an operating system running on the device 110.

The applications 112 can display electronic resources, e.g., web pages, other electronic documents, application pages, or other application content, to a user of the client device 110. The electronic resources can include digital component slots for displaying digital components 115 with the content of the electronic resources. A digital component slot is an area of an electronic resource for displaying a digital component 115. A digital component slot can also refer to a portion of an audio and/or video stream (which is another example of an electronic resource) for playing a digital component 115.

An electronic resource is also referred to herein as a resource for brevity. For the purposes of this document, a resource can refer to a web page, application page, application content displayed by a native application, electronic document (e.g., word processing document or portable document format document), audio stream, video stream, image, search results page, feed source, or other appropriate type of electronic resource or electronic document with which a digital component 115 can be displayed.

As used throughout this document, the phrase “digital component” refers to a discrete unit of digital content or digital information (e.g., a video clip, audio clip, multimedia clip, image, text, or another unit of content). A digital component 115 can electronically be stored in a physical memory device as a single file or in a collection of files, and digital components 115 can take the form of video files, audio files, multimedia files, image files, or text files and include advertising information, such that an advertisement is a type of digital component 115. For example, the digital component 115 may be content that is intended to supplement content of a web page or other resource displayed by the application 112. More specifically, the digital component 115 may include digital content that is relevant to the resource content (e.g., the digital component 115 may relate to the same topic as the web page content, or to a related topic). The provision of digital components 115 can thus supplement, and generally enhance, the web page or application content.

Where this specification describes providing a digital component 115, a person of ordinary skill will recognize that a reference to a digital component can be provided in addition to the digital component 115 or instead of the digital component 115. Thus, for ease of description, any reference made in this document to providing a digital component can refer to providing the digital component, data referencing the digital component, or both, unless logically implausible or stated otherwise. Examples of references to digital components can include resource locators, e.g., Uniform Resource Locators (URLs) and Uniform Resource Identifiers (URI), that indicate a location from which the digital component can be obtained. In cases where a reference to a digital component 115 is provided instead of the digital component 115 itself, the digital component reference can be used to obtain the digital component 115, e.g., by downloading the digital component from a location indicated by a URL or URI.

A digital component 115 can also include, or be associated with, distribution parameters for the digital component. In general, distribution parameters contribute to (e.g., trigger, condition, or limit) the distribution/transmission of the corresponding digital component. For example, the distribution parameters can contribute to (e.g., trigger) the transmission of a digital component by requiring that a digital component request include at least one item of data that satisfies (e.g., matching either exactly or with some pre-specified level of similarity) a corresponding constraint criterion of the digital component. Distribution parameters can also include the category of digital component, e.g., whether it is trusted or untrusted. The distribution parameters for a digital component can also include a selection value that represents an amount that a digital component provider is willing to provide to a publisher for each presentation of the digital component with a resource of the publisher, user interaction with the digital component, and/or completion of a specified event after interacting with the digital component.

Constraint criteria can be any functional specification that, when evaluated by a content platform 145, 150, 152, 155, produces one or more values, which can be, for example, numbers or Boolean values.

The constraint criteria for a digital component 115 can include sensitive and/or non-sensitive constraint criteria. Sensitive constraint criteria are criteria that are evaluated using sensitive data, e.g., sensitive user data. Non-sensitive constraint criteria are criteria that are evaluated using non-sensitive data.

Non-sensitive constraint criteria can be evaluated at untrusted content providers, such as uDSPs 150, 152, although they can also be evaluated at trusted content providers, such as tDSPs. Examples of non-sensitive constraint criteria can include distribution keywords that must be matched (e.g., by electronic documents, document keywords, or terms specified in a digital component request 125a, 125b, 125c) in order for the digital component to be eligible for presentation. For brevity, digital component requests 125a, 125b, 125c are collectively referred to as “digital component request 125.” The terms specified in a digital component request can include, for example, keywords of a resource for which a digital component is being requested or search terms input by a user, e.g., at a search engine resource.

Another example of non-sensitive constraint criteria for a digital component 115 can include contextual parameters that condition eligibility of the digital component 115 based on characteristics of the environment in which the digital component 115 will be displayed. The contextual parameters can be based on the resource (e.g., the URL of a web page) for which a digital component is requested, keywords and/or topic(s) of the resource, a geographic region of the client device 110 for which a digital component is requested, the type of the client device 110 (e.g., mobile device or tablet device) a number of digital components slots of the resource, the type(s) of digital component slots, the location on the resource of the digital component slots, the page viewport, the user scrolling speed, and/or other contextual data. Similar to the keywords, a digital component 115 may be eligible for distribution to the client device 110 if contextual data of the digital component request satisfies, e.g., matches, the contextual parameters for the digital component.

Another example of non-sensitive constraint criteria can be criteria that is based on first-party user data of an entity, e.g., a publisher or digital component provider, that provides content to the client device 110 of the user. First-party data is typically data collected by the entity from direct contact between the user and the entity. For example, a publisher of a website can collect first-party data for a user based on the user's interactions with the website, e.g., using first-party cookies. Although such data may be confidential and should be protected from access by anyone other than the entity and user, it is typically considered less sensitive than third-party data. However, first-party data can be considered sensitive in some cases and, if so, constraint criteria based on first-party data can be considered sensitive constraint criteria.

Examples of first-party constraint criteria can be related to an action performed at a resource of a publisher (e.g., viewing a particular page or item) or a user attribute inferred based on the user's actions at the publisher's resources. For example, a digital component can be eligible if the user views a particular item or is considered to have a particular attribute.

Sensitive constraint criteria are evaluated in the context of sensitive data, e.g., potentially-sensitive user data, and are therefore only evaluated by trusted components, such as trusted tDSP 155. Examples of sensitive constraint criteria can include criteria related to sensitive user data, e.g., demographic information (e.g., user age range, gender, etc.), known or inferred topics of interest, groups that include the user as a member, user activities at resources of multiple domains, and/or other appropriate data. Sensitive constraint criteria can include criteria related to user activities across multiple sites, domains, or applications and/or information about the user (e.g., demographics, interests, etc.) inferred based on the cross-site user activities. An example of sensitive constraint criteria can specify that a digital component is eligible for distribution to a client device 110 of a user only if the user is interested in a particular topic, located in a particular location, and/or visited multiple sites related to a particular topic.

To preserve user privacy, the values of potentially sensitive data that are used to evaluate the sensitive constraint criteria are only stored and evaluated in cleartext within trusted environments, e.g., by a tCP. Such data may also be stored in trusted environments and/or in encrypted form on the user's device. When such values must traverse a network connection, strong encryption can be applied.

In some implementations, the distribution parameters for a digital component 115 can include negative criteria that renders the digital component ineligible if a keyword, contextual parameter, or sensitive data matches a corresponding parameter of the digital component request 125. For example, a digital component provider 160 can specify, in the distribution parameters, that a digital component is not eligible for display on a particular web page, in a particular geographic region, or to users that are interested in a particular topic. A digital component can have distribution parameters with positive criteria (e.g., the digital component is eligible of the criteria is satisfied), negative criteria (e.g., the digital component is not eligible if the criteria is satisfied), or both.

As noted above, the sensitive constraint criteria for a digital component 115 can be based on user data. For example, one positive sensitive constraint criterion might indicate an age range that is likely to find the digital component 115 or a resource linked to by the digital component interesting. In this example, the digital component 115 would be eligible if the user is in that age range. In another example, a sensitive constraint criterion can specify one or more topics (e.g., travel, finance, soccer) of interest. For example, the sensitive constraint criteria for a digital component 115 can include one or more user interest group identifiers that identify one or more corresponding user interest groups for which the digital component is eligible and/or one or more user interest group identifiers that identify one or more corresponding user interest groups for which the digital component is not eligible. Note that sensitive constraint criteria are associated with digital components 115 and therefore provide no information about any actual user, so constraint criteria do not compromise privacy. Instead, the sensitive constraint criteria are evaluated based on actual user data in a trusted environment, e.g., a TEE.

A digital component 115 associated with sensitive constraint criteria based on user data or other sensitive data can be referred to as a trusted digital component. In other words, a trusted digital component is a digital component for which distribution of the digital component is conditioned at least on sensitive constraint criteria, and optionally on non-sensitive constraint criteria as well.

As noted above, digital components 115 can have associated contextual parameters that represent the context in which a digital component 115 should be displayed. Such contextual parameters can indicate, for example, the device type, display size, device capabilities, and/or position of rendering for which the digital component is eligible, among many other examples. As described below, contextual data included in a digital component request can be evaluated with contextual parameters associated with a digital component 115 when determining what digital components 115 to include in a digital component response and/or when determining what digital component(s) 115 to render. A digital component 115 that is associated with contextual criteria and/or other non-sensitive constraint criteria, but not with sensitive constraint criteria, can be referred to as an untrusted digital component.

A client device 110 can also include, or be coupled to, a digital component repository 130, which can be any storage system appropriate for storing digital components 115 and/or a digital component index that identifies digital components and includes the distribution parameters for the digital components. For example, the digital component repository 130 can be a persistent storage system such as a database or file system, or a transient storage system such as a dedicated area of random access memory (RAM). Although shown as being part of or coupled to the client device 110, one or more content platforms 145, 150, 152, 155 can include or be coupled to a digital component repository 130.

When the application 112 loads a resource that includes a digital component slot, the application 112 can generate a digital component request 125 that requests a digital component 115 for display in the digital component slot. In some implementations, the digital component slot and/or the resource can include code (e.g., scripts) that cause the application 112 to request a digital component 115 from an SSP such as the tSSP 145. A digital component request 125 sent by a client device 110 can include non-sensitive data, such as contextual data, generic keyword(s) and/or a query string (e.g. one or more query terms). However, sensitive data can be excluded from the digital component request 125.

In cases where sensitive data is included, the sensitive data are encrypted, as described above. For example, the client device 110 can encrypt the sensitive data using an encryption key (e.g., public key) for a tDSP 155 to which the sensitive data will be sent. Upon receipt of the encrypted data, the tDSP 155 can decrypt the data using the decryption key (e.g., private key) that corresponds to the encryption key for the tDSP 155. The client device 110 can store the sensitive data in storage (e.g., a solid state drive) of the client device 110. The user data can be stored at the user device in encrypted form or in cleartext (e.g., if stored in a secure location).

In cases where the client device 110 provides the user data to multiple tDSPs, the client device 110 can separately encrypt the user data using the encryption key for each tDSP and each tDSP can decrypt the user data using its decryption key that corresponds to (e.g., that is mathematically linked to) its public key.

Further to the descriptions throughout this document, a user may be provided with controls (e.g., user interface elements with which a user can interact) allowing the user to make an election as to both if and when systems, programs, or features described herein may enable collection of user information (e.g., information about a user's social network, social actions, or activities, profession, a user's preferences, or a user's current location), and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

An example process for selecting and providing a digital component 115 for display at a client device 110 is illustrated in stages A-L, which illustrate a flow of data between the components of the environment 100.

In stage A, the application 112 sends a digital component request 125a over the network 105 to a content platform. In this example, the application 112 sends the digital component request to the tSSP 145. As described above, the application 112 can send a digital component request 125a to request a digital component 115 for display in a digital component slot of a resource being (or about to be) displayed by the application 112. The digital component request 125a can include a set of data that can be used by content platforms to select one or more digital components for presentation by the application 112. The data can include non-sensitive data and/or sensitive data. For example, the set of data can include contextual data and/or user data that is considered to be sensitive.

In some implementations, the application 112 encrypts the user data and any other sensitive data before including the data in the digital component request 125a. For example, the application 112 can encrypt the user data using an encryption key of a tDSP 155 from which a digital component is being requested. In this way, only the tDSP 155 can access the user data in cleartext such that the security of the data is preserved during transmission from the client device to the tDSP 155. Cleartext is text that is not computationally tagged, specially formatted, or written in code, or data, including binary files, in a form that can be viewed or used without requiring a key or other decryption device, or other decryption process. If multiple tDSPs 155 are going to be given the opportunity to provide one or more candidate digital components for selection in response to the digital component request 125a, the application 112 can separately encrypt the user data using a corresponding encryption key for each tDSP 155.

In stage B, the tSSP 145 sends a digital component request 125b to one or more tDSPs 155. The digital component request 125b can be the same as the digital component request 125a. In some implementations, the tSSP 145 can generate the digital component request 125b by removing or adding data to the digital component request 125a. For example, if the digital component request 125a includes encrypted data for multiple tDSPs, the tSSP 145 can remove the encrypted data for each other tDSP prior to sending the digital component request 125b to the tDSP 155.

In some implementations, the tSSP 145 can include first-party data in the digital component request 125b. The first-party data can include data derived from the user's interactions with electronic resources of a first-party entity such as a publisher of the resource for which a digital component is being requested. For example, the first-party data can indicate the actions of the user at the resources and/or data derived from the actions, e.g., topics of interest of the user, inferred demographics of the user, etc.

The tSSP 145 can maintain, for the publisher, the first-party data for signed-in users of the resource. If a user is signed into the resource when a digital component request 125a is sent, the digital component request 125a can include data identifying the user so that the tSSP 145 can identify the first-party data of the user and include this first-party data in the digital component request 125b. The tSSP 155 can anonymize the first-party data prior to providing the first-party data to the tDSP 155. For example, the tSSP 155 can remove any user identifying data from the first-party data before providing the first-party data to any other entity.

Note that while the tSSP 145 and the tDSP 155 are shown as separate components, the operations performed by the tSSP 145 and the tDSP 155 can be performed by a single trusted component or by trusted components of a single entity that provides both SSP and DSP services.

In stage C, the tDSP 155 can provide a set of data to the uDSP 150 that is operated by, or on behalf of, the same entity (e.g., same DSP service provider) as the tDSP 155. This set of data can include non-sensitive data from the digital component request 125b. For example, this data can include contextual data and/or first-party data. However, since the uDSP 150 is not a tCP, this set of data may not include the sensitive data.

In stage D, the uDSP 150 can select one or more candidate digital components based on the data received from the tDSP 155. In some implementations, the uDSP 150 can obtain candidate digital components from one or more digital component providers 160. Each uDSP 150 can provide data derived from or relating to the digital component request 125b to the digital component providers 160. For example, the uDSP 150 can provide the contextual data and/or first-party data for the digital component request 125b to the digital component providers 160.

The digital component providers 160 can provide, to the uDSP 150, candidate digital components that are responsive to the contextual data received from the uDSP 150. For example, the digital component providers 160 can provide candidate digital components appropriate to the contextual data such as the location of the client device 110 matching a location criterion for the digital component. For example, if a digital component request 125 is for an image appropriate for a small screen (e.g., a cell phone screen), the digital component providers 160 can provide image digital components that are formatted for a small screen and not provide video digital components.

In some implementations, the uDSP 150 can store the digital components and/or the distribution parameters for digital components of the digital component providers 160. The uDSP 150 can use the distribution parameters (e.g., the non-sensitive constraint criteria of the distribution parameters) to select untrusted digital components to send to the tDSP 155. In some implementations, the uDSP 150 can also select trusted digital components (e.g., using the non-sensitive constraint criteria) and send the selected trusted digital components and sensitive constraint criteria for the trusted digital components to the tDSP 155. For example, trusted digital components can have, in addition to sensitive constraint criteria, non-sensitive constraint criteria that can be evaluated based on non-sensitive data, e.g., contextual data and/or first-party data. If a digital component's non-sensitive criteria are satisfied based on the data received from the tDSP 155, the uDSP 150 can provide the digital component and its distribution parameters, e.g., its sensitive constraint criteria and/or selection value, to the tDSP 155.

In addition, in some implementations each digital component provider 160 can provide, for each digital component, or for any subset of the digital components, distribution parameters. In some implementations, the uDSP 150 can obtain distribution parameters using other techniques, such as retrieving them from a database or other storage system.

In some implementations, the uDSP 150 can maintain one or more digital component repositories. The digital component repository maintained by the uDSP 150 is also referred to as a second untrusted repository. The uDSP 150 can store the digital components received from the digital component providers 160 in one or more second untrusted repositories.

The uDSP 150 can select, from among digital components stored in the second untrusted repository and/or digital components received from the digital component providers, candidate digital components to provide to the tDSP 155. The uDSP 150 can select the candidate digital components based on the data received from the tDSP 155 and the distribution parameters for the digital components stored by the uDSP 150 in the second untrusted repository and/or digital components received from the digital component providers 160. For example, the uDSP 150 can select, as candidate digital components, each digital component for which the non-sensitive data received from the tDSP 150 satisfies the non-sensitive constraint criteria of the digital component.

In stage E, the tDSP 155 can receive candidate digital components from the uDSP 150. The candidate digital components can include zero or more untrusted digital components and zero or more trusted digital components. For example, the received candidate digital components can include one or more untrusted digital components and/or one or more trusted digital components. The tDSP 155 can also receive distribution parameters, which can include constraint criteria and/or a selection value, for the candidate digital components.

In some implementations, the tDSP 155 can maintain one or more digital component repositories. The digital component repository maintained by the tDSP 155 is also referred to as a second trusted repository. The tDSP 155 can store the candidate digital components received from the uDSP 150 in one or more second trusted repositories.

In stage F, the tDSP 155 can use the distribution parameters and sensitive data (e.g., user data) to select a subset of the candidate digital components to provide to the tSSP 145 in response to the digital component request 125b. The tDSP 155 can access the user data by decrypting the encrypted user data using its decryption key. For example, the tDSP 155 can filter one or more candidate digital components from consideration and optionally determine the selection values for the remaining one or more candidate digital components that remain after the filtering. The tDSP 155 can filter from consideration any candidate digital component for which the user data does not satisfy the sensitive constraint criteria for the candidate digital component.

In some implementations, the tDSP 155 can determine the selection value for a candidate digital component by adjusting (e.g., increasing or decreasing) an initial selection value that is part of the distribution parameters for the candidate digital component. For example, the uDSP 150 can generate the initial selection value for a candidate digital component, e.g., based on the contextual data of the digital component request 125b, and include the initial selection value in the distribution parameters for the candidate digital component.

In the example of FIG. 1, the tDSP 155 is operated by or on behalf of the same entity as the uDSP 150. The entity that operates the uDSP 150 and the tDSP 155 can thus provide both untrusted digital components that are eligible for distribution to the client device 110 based on the contextual data of the digital component request 125a and trusted digital components that are eligible based on the user data of the digital component request 125a. However, the uDSP 150 may not be allowed to receive or have access to the user data in cleartext. Instead, the uDSP 150 provides distribution parameters that include sensitive constraint criteria in its response to the digital component request of stage C. This enables the tDSP 155 to generate a selection value for any of the trusted digital components that are eligible for distribution to the client device 110 based on the user data in a TEE.

In some implementations, the tDSP 155 can receive candidate digital components from digital component providers 160. For example, the tDSP 155 can obtain candidate digital components from one or more digital component providers 160 such as the digital component providers 160. The tDSP 155 can provide data derived from or relating to the digital component request 125b to the digital component providers 160. For example, the tDSP 155 can provide, to the digital component providers 160, the contextual data for the digital component request 125b.

The digital component providers 160 can provide digital components that are responsive to the contextual data. In some implementations, the tDSP 155 can store the candidate digital components received from the digital component providers in one or more of the second trusted repositories.

The tDSP 155 can select candidate digital components to provide to the tSSP 145 in response to the digital component request 125b. At this stage, the tDSP 155 has a set of candidate digital components received from the uDSP 150 and optionally candidate digital components received from digital component providers 160. The candidate digital components received from the uDSP 150 have been selected based on the non-sensitive data of the digital component request 125b.

The tDSP 155 can select the candidate digital components to provide to the tSSP 145 by filtering, from the candidate digital components, those that have sensitive constraint criteria that is not satisfied by the user data received from the tSSP 145. As the untrusted candidate digital components do not have sensitive constraint criteria, the untrusted candidate digital components would not be filtered.

The tDSP 155 can also select the candidate digital components to provide to the tSSP 145 by scoring the candidate digital components based on the sensitive data and/or the non-sensitive data received from the tSSP 145 in the digital component request 125b. For example, the score for each candidate digital component can be based on a level of match between the sensitive and/or non-sensitive data and the distribution parameters of the candidate digital component. The score for a digital component can be based on the selection value for the candidate digital component and/or a predicted performance of the digital component (e.g., a predicted user interaction rate). In this example, the tDSP 155 can select the candidate digital components having the highest scores (e.g., a predetermined number of candidate digital components having the highest scores) or each candidate digital component having a score that satisfies a threshold.

For example, the tDSP 155 can generate a score for each candidate digital component using one or more trained machine learning models or otherwise. In a particular example, the tDSP 155 can generate a predicted performance metric for each digital component using the data received from the tSSP 145 (e.g., sensitive and/or non-sensitive data) and/or distribution parameters for the digital component as input to a first machine learning model. The tDSP 155 can generate a selection value for each digital component using the data received from the tSSP 145 (e.g., sensitive and/or non-sensitive data) and/or distribution parameters for the digital component as input to a second machine learning model. The tDSP 155 can then compute the score for each digital component using a combination of the predicted performance metric and the selection value, e.g., a product of the predicted performance metric and the selection value. The tDSP 155 can select one or more of the digital components based on the scores. Using the sensitive data in a secure environment in this way enables more accurate predicted performance metrics and selection values, resulting in more accurate scoring and better resource utilization without leaking sensitive data.

In some implementations where at least part of the tDSP 155 is implemented on the client device 110, the tDSP 155 can be configured to perform operations such as store candidate digital components, receive candidate digital components, score digital components, and/or select candidate digital components on the client device 110.

In stage G, the tDSP 155 can provide the selected candidate digital component(s) and distribution parameters (which can include adjusted selection values) to the tSSP 145. For example, the tDSP 155 can provide zero or more untrusted candidate digital components and zero or more trusted candidate digital components to the tSSP 145.

In stage H, the tSSP 145 provides the digital component request 125c to one or more other uDSPs (shown in FIG. 1 as uDSP 152). In some implementations, each uDSP 152 that receives a digital component request 125c directed from the tSSP 145 can be operated by an entity that does not operate a corresponding tDSP that interacts with the tSSP 145.

If user data (which is encrypted) is included in the digital component request 125a, the tSSP 145 removes and stores the user data before forwarding the digital component request 125c. Note that since the user data are encrypted, forwarding the user data would not introduce a privacy exposure, but would result in extra network traffic. In some implementations, the tSSP 145 can generate a new digital component request 125c that does not include the encrypted user data instead of removing the encrypted data and forwarding the digital component request 125a as 125c. The digital component request 125c can include non-sensitive data, e.g., contextual data and/or first-party data.

In stage I, the uDSP 152 selects one or more candidate digital components based on the data of the digital component request. The uDSP 152 can obtain and select candidate digital components in a similar manner as the uDSP 155, as described above. For example, the uDSP 152 can obtain candidate digital components from digital component providers 160 and/or from a digital component repository. In stage J, the tSSP 145 can receive candidate digital components from the uDSP 152. The tSSP 145 can also receive selection values for each of the candidate digital components. The uDSP 152 can be configured to select candidate digital components based on the first party data or contextual data and send the one or more selected candidate digital components to the tSSP 145.

In stage K, the tSSP 145 can select one or more digital components 115 from among a set of candidate digital components. The set of candidate digital components can include the digital component(s) received from the tDSP 155 (e.g., trusted and/or untrusted candidate digital components provided by the tDSP 155) and optionally candidate digital components received from other tDSPs or other uDSPs such as the uDSP 152. For example, stages B-G can be performed for multiple tDSPs to generate the set of candidate digital components. Similarly, stages H-J can be performed for multiple uDSPs to obtain additional candidate digital components for inclusion in the set of candidate digital components. In some implementations, stages H J can be performed in parallel with stages B-G to reduce latency in selecting and providing digital components to client devices 110.

The tSSP 145 can select the digital component(s) 115 based on the selection values. For example, the tSSP 145 can select the digital components 115 having the highest selection value or a highest score that is based on the selection value and a predicted performance (e.g., predicted interaction rate) of the digital component.

In stage L, the tSSP 145 can send the selected digital components 115 to the client device 110 for rendering. The client device 110 can also provide the selected digital component(s) 115 to one or more applications 112 and/or store the digital component(s) 115 in a digital component repository 130.

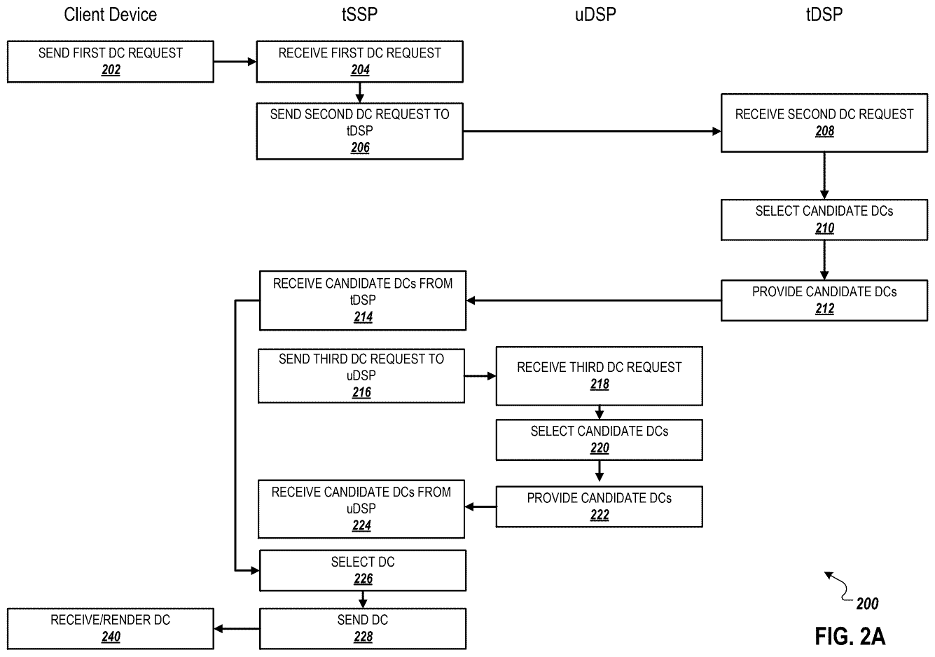

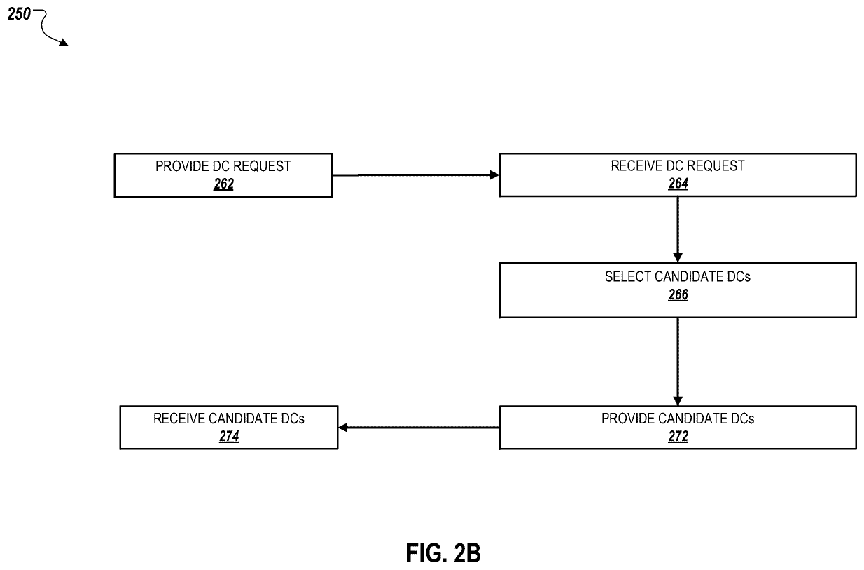

FIG. 2A is a flow diagram of an example process 200 for privacy-preserving content selection. For convenience, the process 200 will be described as being performed by the components of the environment of FIG. 1, e.g., client devices 110 and content platforms 145, 150, 152, 155 of FIG. 1 appropriately programmed to perform the process 200. Operations of the process 200 can also be implemented as instructions stored on one or more computer readable media, which may be non-transitory, and execution of the instructions by one or more data processing apparatus can cause the one or more data processing apparatus to perform the operations of the process 200. One or more other components described herein can perform operations of the process 200.

A client device sends (202) and a tSSP receives (204) a first digital component request that requests one or more digital components for display at the client device. An application running on the client device can generate the first digital component request in response to various operations on the client device, including rendering a resource that includes a digital component slot, in response to a user action (e.g., submitting a query, opening an application, interacting with an application, etc.), or another operation.

The first digital component request can include sensitive and non-sensitive data. For example, the first digital component request can include, as sensitive data, encrypted user data for the user of the client device. The first digital component request can also include, as non-sensitive data, contextual data. Examples of user data, contextual data are described above.

Throughout this specification, when information (e.g., a digital component request) is provided by one component and received by another component, the corresponding providing and receiving operations can be performed using any appropriate technique. For example, if the providing component uses HyperText Transfer Protocol (HTTP) or HTTP-Secure (HTTP-S), the receiving component can use the corresponding HTTP or HTTP-S operations to receive the information. In another example, the providing component can make a Remote Procedure Call (RPC) to the receiving component, and the RPC operation results in the transfer of the data. Message passing techniques, such as passing data over a TCP/IP socket from the providing component to the receiving component, can also be used. A person of ordinary skill will recognize that other techniques for passing data can also be used.

The tSSP can send (206) to one or more tDSPs a second digital component request. The second digital component request can include sensitive data and/or non-sensitive data. For example, the second digital component request can include encrypted user data and/or contextual data of the first digital component request. As described above, user data can be encrypted using the private key of the tDSP and therefore would not be available to the tSSP. The second digital component request can also include first-party data for a publisher of the resource for which a digital component is being requested.

The one or more tDSPs can receive (208) the second digital component request from the tSSP.

The tDSP can select (210) candidate digital components to provide to the tSSP in response to the second digital component request. For example, in examples where the same entity operates both a uDSP and a tDSP, as described in more detail with reference to FIG. 2B, the tDSP can obtain candidate digital components by sending a digital component request to the corresponding uDSP.

FIG. 2B is a flow diagram of an example process 250 for obtaining digital components. In some implementations, a uDSP operated by or on behalf of the same entity as the tDSP can be used to obtain digital components. For convenience, the process 250 will be described as being performed by components for obtaining digital components, such as the tDSP (e.g., tDSP 155), and a uDSP (e.g., uDSP 150 of FIG. 1). Operations of the process 250 can also be implemented as instructions stored on one or more computer readable media, which may be non-transitory, and execution of the instructions by one or more data processing apparatus can cause the one or more data processing apparatus to perform the operations of the process 250. One or more other components described herein can perform operations of the process 250. The process 250 can be performed by multiple tDSPs (e.g., multiple tDSPs 155 of FIG. 1).

The tDSP can provide (262) a digital component request to a uDSP operated by the same entity as the tDSP. The tDSP can remove the encrypted user data from the second digital component request received in operation 208 of FIG. 2A, or can generate a new digital component request that does not include the encrypted user data before providing the digital component request to the uDSP. The digital component request can include first-party data and/or contextual data.

The uDSP can receive (264) the digital component request. The uDSP can select (266) candidate digital components based on the digital component request. The candidate digital components can include zero or more trusted digital components and/or zero or more untrusted digital components.

The uDSP can select zero or more untrusted digital components. The uDSP can evaluate the contextual data and/or the first-party data included in the digital component request and non-sensitive criteria associated with the digital components, or a subset of the digital components, available to the uDSP. In some implementations, the uDSP can process all or a subset of the contextual and/or first-party data using a machine learning model that is configured to produce a prediction that indicates the relevance of the digital component to the digital component request. In some implementations, the uDSP can select, as the untrusted digital component, the digital component with the highest predicted relevance. In some implementations, the uDSP can select as untrusted digital components all candidate digital components for which the prediction satisfies a configured threshold.

The uDSP can select trusted digital components. The uDSP can use various techniques for selecting the trusted digital components. For example, the uDSP can provide digital components relevant to particular user segments, such as users who are 18 to 24 years of age, users who have an interest in a particular sport, users who have an interest in shoes, among many other examples. The uDSPs do not have access to specific information about device users (e.g., users' ages), so the uDSPs provide constraints on using the trusted digital components to a trusted content platform (e.g., the tDSP), and the trusted content platform can determine whether those constraints are satisfied, as described elsewhere herein. The uDSP can select the candidate digital components in a similar manner as described above with reference to stage D of FIG. 1.

The uDSP can provide (272) the selected candidate digital components. The uDSP can also provide distribution parameters for at least some of the candidate digital components, e.g., for any trusted digital components included in the response. As described above, the distribution parameters for a digital component can include sensitive and/or non-sensitive constraint criteria and a selection value.

The selection values can be used, at least in part, by a trusted content provider when determining a digital component to render, as described further below. As some selection values can be adjusted by the tDSP, these selection values can be referred to as initial selection values.

The tDSP can receive (274) the candidate digital components (trusted and/or untrusted) and distribution parameters for the candidate digital components.

Returning to FIG. 2A, the tDSP can select a subset of the candidate digital components from the received candidate digital components.

In some implementations, the tDSP can adjust selection values for the candidate digital components, or for a subset of the digital components. In some implementations, the tDSP receives an initial selection value and the tDSP can determine a selection value by adjusting the initial selection value based at least in part on the constraining values. Note that in the case where no initial selection value has been set for a digital component (e.g., the value is NULL) the tDSP can adjust the selection parameter from the undefined (or NULL) value.

The tDSP can use various techniques to adjust the selection values. In some implementations, the tDSP can adjust the selection values based at least in part on matching and/or relevance. For example, the tDSP can increase the selection value by a configured percentage (e.g., 1%, 5%, 10%, etc.) for each constraint criterion satisfied by the user data. In some implementations, the tDSP can increase the selection value based on prior user behavior. For example, if a user visited sites assigned to a particular category or topic of interest (e.g., shoes, soccer, travel, etc.), and a constraint criterion relates to the category, the selection value can be increased based on the number of visits by the user to sites assigned to the category. Information relating to such visits can be included in encrypted user data that is provided in the digital component request to the tDSP. In some implementations, the relevance score can be decreased if user data does not exist for constraint criteria.

Since many factors can influence the adjustment to the selection value, in some implementations, the tDSP can adjust a selection value based at least in part on a computed dot product of the factors influencing the adjustment (e.g., alignment of constraining values and constraint criteria). For example, for each user parameter (e.g., age, location, topic of interest, web page visited), a first vector can contain a user value representing whether the user data contains that feature (e.g., location can be 1 or 0 depending on whether the user in that location, interest can be 0.9 if interested or 0.1 if not). A second vector can represent the candidate digital component, and includes the same features, but weighted according to the digital component (e.g., if the digital component is designated as relevant to a location, the vector contains a 1 value, and if not then the vector contains a 0). A dot product of the two vectors is computed and used as the selection value, or used to adjust the selection value.

In some implementations, the tDSP can create a first embedding vector from the candidate digital component using a deep neural network (DNN) that has been trained to generate embedding vectors from candidate digital components and a second embedding vector from the user parameters using a DNN that has been trained to generate embedding vectors from user parameters. The tDSP can adjust or determine a selection value based at least in part on a computed dot product of the first embedding vector and the second embedding vector.

In some implementations, the tDSP can adjust a selection value at least in part using a DNN or other type of machine learning model that has been trained to produce selection value adjustments. The tDSP can process an input that contains one or more candidate digital components and/or the user parameters to produce an adjustment value.

In some implementations, the tDSP can generate a selection value using a DNN other type of machine learning model that has been trained to produce selection values. The tDSP can process an input that contains one or more candidate digital components and/or the user parameters to produce the selection value. Combinations of the techniques described in this specification can also be used, as can alternate techniques (alone or in combination with the techniques described herein).

The tDSP can apply the adjustment value to the selection value to produce an adjusted selection value using one or more of various techniques. For example, the selection value can be linearly scaled by the adjustment value. In another example, the adjustment value can be added to the selection value. Other techniques for adjusting the selection using the adjustment value can be used.

In some implementations, the tDSP can use the initial and/or adjusted selection values to select the candidate digital components to provide to the tSSP in response to the second digital component request. For example, the candidate digital components can include all digital components with a selection value that satisfies a threshold; the candidate digital components can include a configured number of digital components (e.g., the N digital components with the highest selection values; or the candidate digital components can include a configured number of digital components, but only if the selection value for those components satisfies a threshold. Other techniques can also be used.

As described above, the tDSP can determine a score for each candidate digital component using the selection value and a predicted performance metric for the digital component. The tDSP can then select the candidate digital components to provide to the tSSP based on the scores.

In some implementations the tDSP can remove from the set of trusted digital components, and using the constraint criteria and user data, trusted digital components for which the set of constraint criteria is not satisfied, to form a set of filtered digital components. The tDSP can use various techniques for removing trusted digital components. For example, the tDSP can remove the digital component from consideration if a user data does not satisfy a constraint criterion; if user data do not exist for a configured number of constraint criteria; if the number of a times the user data satisfies constraint criteria does not satisfy a configured threshold (e.g., at least 2 constraint criteria must be satisfied; etc.) In some implementations, such factors can be considered both when filtering digital components, and for digital components that are not filtered, when adjusting the relevance score. The candidate digital components can be selected from the digital components that were not filtered, e.g., using the selection values, described above.

In some implementations, each of the tDSPs maintains a second trusted repository of digital components. Each of the tDSPs can determine one or more candidate digital components from the second trusted repository.

The tDSP can provide (212) the candidate digital components as first candidate digital components and the tSSP can receive (214) the first candidate digital components. The tDSP can also provide a selection value or updated selection value for each candidate digital component. The candidate digital components can include a proper subset of the set of the trusted digital components selected based on the user data and, for each trusted digital component, an updated selection value generated by the tDSP based on the user data. A proper subset of a set S is a subset of S that contains fewer values than S contains. The candidate digital components can also include the untrusted candidate digital component(s).

The tSSP can send (216) a third digital component request to each of one or more uDSPs. The third digital component request sent to each uDSP can include first-party data and/or contextual data of the first digital component request. The tSSP can remove the encrypted user data from the first digital component request or generate a third digital component request that does not include the encrypted user data before providing the third request to each uDSP.

Each of the one or more uDSPs can receive (218) the third digital component request. Each uDSP can select (220) one or more candidate digital components. Each uDSP can also determine distribution parameters associated with the candidate digital components. The candidate digital components can include trusted and/or untrusted candidate digital components.

Each uDSP that receives the digital component request can select candidate digital components and the distribution parameters associated with the digital components. The candidate digital components can include zero or more untrusted digital components and zero or more trusted digital components along with distribution parameters that can include sensitive constraint criteria for the trusted digital components. Each uDSP can select candidate digital components in a similar manner as described above with reference to stage I of FIG. 1.

The uDSP(s) can provide (222) the candidate digital components as second candidate digital components. The uDSP can also provide one or more selection values, each associated with one or more of the candidate digital components. The selection values can be used, at least in part, by the tSSP when determining a digital component to provide to the client device.

The tSSP can receive (224) second candidate digital components from the one or more uDSPs. The obtained digital components can include one or more untrusted digital components selected based on the contextual data and/or first-party data of the third digital component request. In some implementations, operations 206-214 and operations 216-224 can be performed in parallel, reducing the latency compared to performing the groups of operations sequentially.

From the candidate digital components received from the one or more uDSPs and the one or more tDSPs, the tSSP can select (226) one or more digital components to provide to the client device. For example, the tSSP can generate or update a selection value for each candidate digital component of a set of candidate digital components that includes the first candidate digital components and second candidate digital components based on the contextual data. The tSSP can select the given digital component from the first candidate digital components and second candidate digital components based on the corresponding selection value for each candidate digital component. Additionally, the set of candidate digital components can include digital components received from other tDSPs and/or other uDSPs.

The tSSP can use the selection values to select a digital component. For example, the tSSP can select the digital component with the highest selection value. In some examples, the tSSP can select multiple digital components from the candidate digital components.

In some implementations, the tSSP can select the digital components having a highest score that is based on the selection value and a predicted performance (e.g., predicted interaction rate) of the digital component.

The tSSP can send (228) the selected digital component(s) to the client device. The client device can receive and render (240) the digital component(s).

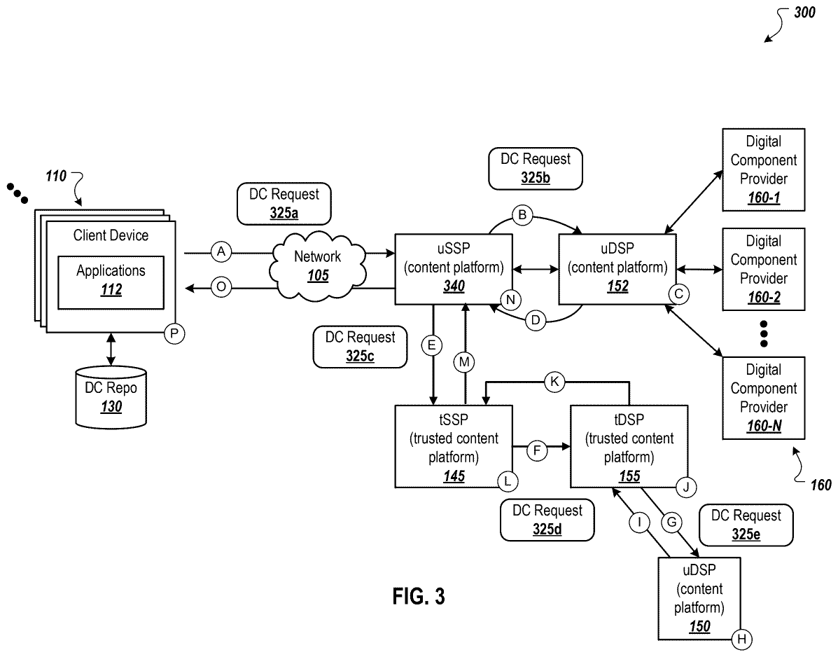

FIG. 3 is a block diagram of an example environment 300 in which digital components 115 are selected for client devices 110 in a privacy preserving manner. The environment 300 is similar to the environment 100 of FIG. 1 in that the environment 300 includes a data communication network 105 that connects client devices 110 to content platforms, which can include SSP 145 and DSPs 150, 152, 155. This example environment 300 also includes an untrusted SSP (uSSP) 340 that interacts with the client devices 110, one or more uDSPs 152 and a tSSP 145. The uSSP 340 can also be referred to as the first untrusted content platform.

In some implementations, uDSP 150 and tDSP 155 are operated by or on behalf of a first entity, and uSSP 340 and tSSP 145 are operated by or on behalf of a second entity. That is, one entity provides both the trusted and untrusted SSP functionality, and similarly, one entity provides both the trusted and untrusted DSP functionality. In this way, a DSP can select candidate digital components to provide in response to a request in two different environments and using two different types of data, e.g., sensitive data that includes potentially sensitive user data and non-sensitive data that can include contextual data and/or first-party data. Further, to simplify the diagram, FIG. 3 shows requests flowing from a single uSSP 340 to a single uDSP 152, but uSSP 340 can send requests to any number of uDSPs 152. Similarly, the tSSP 145 is shown as sending a request to a single tDSP 155, but can send requests to any number of tDSPs 155.

An example process for selecting a digital component 115 for display at a client device 110 is illustrated in stages A-P, which illustrate a flow of data between the components of the environment 300. The digital component requests 325 are similar to the digital component requests 125 in that the digital component requests 325 can include sensitive and/or non-sensitive data depending on the request 325.

In stage A, the application 112 sends a digital component request 325a over the network 105 to the uSSP 340. As described above, the application 112 can send a digital component request 325a to request a digital component 115 for display in a digital component slot of a resource being displayed by the application 112. This digital component request 325a can include sensitive data that can include user data for a user of the client device 110. The sensitive data can be encrypted, as described above. Example types of user data are described above. This digital component request 325a can also include non-sensitive data, e.g., contextual data. Examples of contextual data are described above.

In stage B, the uSSP 340 sends a digital component request 325b to one or more uDSPs such as uDSP 152. If user data is included in the digital component request 325a, the uSSP 140 removes and stores the user data before forwarding the digital component request 325b. In some implementations, the uSSP 340 can generate a new digital component request 325b that does not include the encrypted user data instead of removing the encrypted data and forwarding the digital component request 325a. The digital component request 325b can include contextual data and/or first-party data related to the user and the resource for which the digital component is being requested.

In stage C, each uDSP 152 can obtain candidate digital components from one or more digital component providers 160 and/or from a digital component repository. In some implementations, each uDSP 150 can provide the digital component request 325b, or data derived from or relating to the digital component request 325b (e.g., contextual data), to the digital component providers 160. In response, the digital component providers 160 can provide candidate digital components that are responsive to the request from the uDSP 150.

The uDSP 152 can obtain zero or more trusted digital components and/or zero or more untrusted digital components. The uDSP 152 can use the data in the digital component request 325b to select candidate digital components to provide in response to the digital component request in a similar manner as uDSPs 150, 152 of FIG. 1.

In stage D, the uDSP 152 provides the candidate digital components and distribution parameters for at least some of the digital components to the uSSP 340. As described above, the distribution parameters can include constraint criteria and/or selection values.

In stage E, the uSSP 340 provides the candidate digital components from the uDSP 152 to the tSSP 145. The uSSP 340 can also provide a digital component request 325c to the tSSP 145. The digital component request 325c can include the stored encrypted user data from digital component request 325a and/or other data of the digital component request 325a. For example, in stage E, the uSSP 340 can provide the candidate digital components received from each uDSP 152 and a digital component request 325c that includes the sensitive data and the non-sensitive data of the digital component request 325a.

In stage F, the tSSP 145 provides a digital component request 325d (which can be the same as digital component request 325c) to the tDSP 155. In this example, each tDSP 155 can communicate directly, e.g., without going through an SSP, with a uDSP 155 operated by or on behalf of the same entity, e.g., the same DSP service provider. This enables the tDSP 155 to obtain candidate digital components from its corresponding uDSP 150 directly, as described in more detail below.

In implementations in which this direct communication is not possible, the corresponding uDSP for each tDSP 155 can be a uDSP 152. In this way, the tDSP 155 can receive candidate digital components from the uDSP 152 by way of the uSSP 340 and tSSP 145. For example, the digital component request 325d sent to the tDSP 155 can include the candidate digital components and distribution parameters that the uSSP 340 received from the corresponding uDSP 152. If the tSSP 145 sends a digital component request 325d to multiple tDSPs, the digital component request 325d sent to a tDSP 155 will only include the candidate digital components obtained from the corresponding uDSP 152 operated by or on behalf of the same entity as the tDSP 155.

In some implementations, each tDSP 155 may not have a corresponding uDSP 150, 152. In such implementations, the tDSP 155 can store all of its candidate digital components in a digital component repository. This approach may be simpler to implement, e.g., by reducing communications between content platforms and distributing processes among multiple content platforms. However, operations performed in a trusted environment can be more computationally intense than the same operations performed in untrusted environments.

In stage G, the tDSP 155 can send a digital component request 325e to the uDSP 150. The digital component request 325e can include non-sensitive data, e.g., first-party data and/or contextual data.

In stage H, the uDSP 150 can select digital components to provide to the tDSP 155 based on the non-sensitive data. The uDSP 150 can also generate or obtain distribution parameters for the candidate digital component. For example, the uDSP 150 can obtain constraint criteria for the candidate digital components and/or determine a selection value for each candidate digital component. The uDSP 150 can select the candidate digital components and/or generate selection values in a similar manner as described above with reference to the uDSP 150 of FIG. 1. In stage I, the tDSP 155 can receive candidate digital components and distribution parameters from the uDSP 150.

In stage J, the tDSP 155 can use the distribution parameters and user data to select candidate digital components to provide to the tSSP for inclusion in a selection process for selecting, from candidate digital components, one or more digital components to send to the client device 110 in response to the digital component request 325a. The tDSP 155 can select the candidate digital components and/or generate selection values for the candidate digital components in a similar manner as described above with reference to the tDSP 155 of FIG. 1. For example, the tDSP 155 can generate scores for the candidate digital components based on selection values and/or predicted performance metrics and select the candidate digital components based on the scores. As described above, this scoring can be based on user data since the tDSP 155 generates the scores. If initial selection values are received from the uDSP 150 based on the non-sensitive data, the tDSP 155 can update the selection value based on the user data, as described above.

In stage K, the tDSP 155 can provide the selected candidate digital components and selection values for the selected candidate digital components to the tSSP 145. The selected candidate digital components can include zero or more trusted digital components and/or zero or more untrusted digital components.

In some implementations, stages E-M are performed in parallel with stages B-D to reduce latency in obtaining candidate digital components. In such cases, stage E can include sending the digital component request 325c to the tSSP 145. Once candidate digital components are received from each uDSP 152, the uSSP 340 can provide those candidate digital components and any distribution parameters for the candidate digital components to the tSSP 145.

In stage L, the tSSP 145 can select one or more digital components from among a set of candidate digital components. This set of candidate digital components can include candidate digital components received from each tDSP 155 and/or each uDSP 152. The tSSP 145 can select the one or more digital components based on the selection values for the candidate digital components and/or scores for the candidate digital components. The score for a candidate digital component can be based on the selection value for the digital component and/or a predicted performance of the candidate digital component. For example, the tSSP 145 can select the candidate digital component(s) having the highest selection value(s) or highest score(s).

In stage M, the tSSP 145 can send the selected digital component(s) to the uSSP 340. In some implementations, the tSSP 145 can encrypt the digital component(s) before sending the digital components. For example, the tSSP 145 can encrypt each selected digital component using an encryption key (e.g., public key) of the client device 110. In this way, only the client device 110 can decrypt the selected digital component(s), which can prevent the uSSP 340 and any entity that intercepts the transmission of the selected digital component(s) from learning about which digital components are provided to users which can reflect the users' interests.

In some implementations, the client device 110 performs a final selection process for selecting one or more digital components to present to the user of the client device 110. In such examples, the tSSP 145 can send the selection parameters and optionally other distribution parameters for the selected digital component(s) to the uSSP 340.

In stage N, the uSSP 340 can optionally filter the selected digital components, e.g., in cases in which the final selection is performed at the client device 110. For example, the uSSP 340 can use publisher controls that define types of digital components that can be presented with resources of the publisher to filter out any digital components that are not eligible for display with the publisher's resource.

In stage O, the uSSP 340 can provide the selected digital component(s) to the client device 110. If filtering is used, the uSSP 340 can send the selected digital components that remain after the filtering to the client device 110.

In stage P, the application 112 presents selected digital component(s). In some implementations in which the client device 110 does not perform the final selection process, the application 112 can present each selected digital component received from the uSSP 340. In implementations in which the client device 110 performs the final selection process, the client device 110 can select one or more digital components to present to the user.

If a trusted digital component is selected, the client device 110 can decrypt the trusted digital component (if encrypted by the tSSP 145) using a decryption key of the client device 110. The application 112 can then present the selected digital component(s).

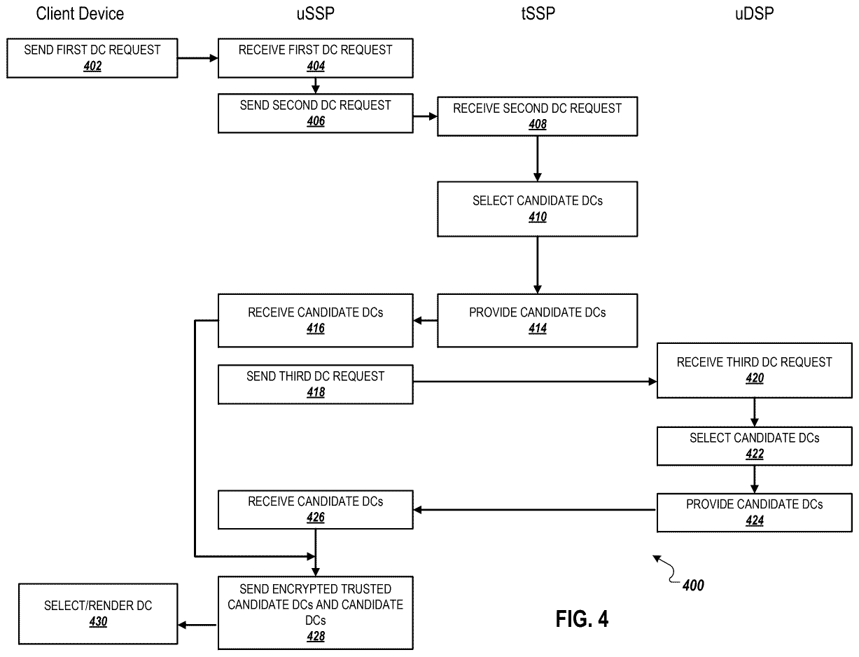

FIG. 4 is a flow diagram of an example process 400 for privacy-preserving content selection. For convenience, the process 400 will be described as being performed by the components of the environment 300 of FIG. 3, e.g., client devices 110 and content platforms 340, 145, 150, 152, 155 of FIG. 3 appropriately programmed to perform the process 400. Operations of the process 400 can also be implemented as instructions stored on one or more computer readable media, which may be non-transitory, and execution of the instructions by one or more data processing apparatus can cause the one or more data processing apparatus to perform the operations of the process 400. One or more other components described herein can perform operations of the process 400.

A client device sends (402) and a uSSP receives (404) a first digital component request that requests one or more digital components for display at the client device. An application running on the client device can generate the digital component request in response to various operations on the client device, including rendering a resource that includes a digital component slot, in response to a user action (e.g., submitting a query, opening an application, interacting with an application, etc.), or another operation.

The first digital component request can include sensitive data that can include user data for a user of the client device. The sensitive data can be encrypted, as described above. Example types of user data are described above. The first digital component request can also include non-sensitive data, e.g., contextual data. Examples of contextual data are described above.

The uSSP can send (406) a second digital component request to a tSSP. p As described above, the uSSP and the tSSP can be operated by or on behalf of the same entity, e.g., an entity that provides SSP services. The second digital component request can include all or a portion of the data included in the first digital component request.

The tSSP can receive (408) the second digital component request. The tSSP can select (410) one or more candidate digital components. For example, the tSSP can obtain candidate digital components from one or more tDSPs. The tSSP can send a digital component request to each tDSP and receive candidate digital components from each tDSP, as described in further detail above with reference to stages F-K of FIG. 3.

The tSSP can then select (412) a subset of the candidate digital components from the received digital components based on selection values for the digital components. For example, the tSSP can select the candidate digital components with the highest selection values. In some implementations, the tSSP can select the candidate digital components having a highest score that is based on the selection value and a predicted performance (e.g., predicted interaction rate) of the digital component.

The tSSP can provide (414) the selected candidate digital component as encrypted candidate digital components to the uSSP. In some implementations, the tSSP can encrypt the each selected candidate digital component before sending the selected candidate digital component to the uSSP. For example, the tSSP can encrypt each selected candidate digital component using an encryption key of the client device. These candidate digital components can be referred to as trusted digital components or encrypted trusted digital components since they are obtained using trusted content platforms.

The uSSP can receive (416) the candidate digital components from the tSSP.

The uSSP can send (418) a third digital component request to one or more uDSPs. Each third digital component request can include the non-sensitive data of the first digital component request. When first-party data is included, the uSSP can send, to each uDSP, only the first-party data of that uDSP.

Each uDSP can receive (420) a third digital component request. The uDSP can select (422) candidate digital components. For example, the uDSP can obtain candidate digital components as described above with reference to stage C of FIG. 3.

Each uDSP can provide (424) candidate digital components, and the uSSP can receive (426) the candidate digital components. In addition, each uDSP can provide, to the uSSP, distribution parameters, e.g., selection values, for the candidate digital components.

In some implementations, operations 406-416 and operations 418-426 can be performed in parallel, reducing the latency compared to performing the groups of operations sequentially.

The uSSP can send (428) candidate digital components to the client device. For example, the uSSP can send the candidate digital components received from the tSSP and the candidate digital components received from the uDSP(s) to the client device.

In some implementations, operations 418-426 are performed before operation 410. In this example, the uSSP can receive the candidate digital components from the uDSP(s) and provide the digital components and their distribution parameters to the tSSP. The tSSP can then select candidate digital components from those received from the tDSP and the uDSP(s) and provide the selected candidate digital components to the uSSP.

The uSSP can filter the candidate digital components prior to providing candidate digital components to the client device. For example, the uSSP can filter the candidate digital components based on publisher controls, as described above with reference to stage N of FIG. 3.

The client device can select one or more of the digital components for presentation to the user of the client device. In some implementations, the client device can use the selection values to select a digital component. For example, the client device can select the digital component with the highest selection value. In some examples, the client device can select multiple digital components from the candidate digital components received from the uSSP. In some implementations, the client device can select the digital components having a highest score that is based on the selection value and a predicted performance (e.g., predicted interaction rate) of the digital component. The client device can then present, e.g., render, the selected digital component.

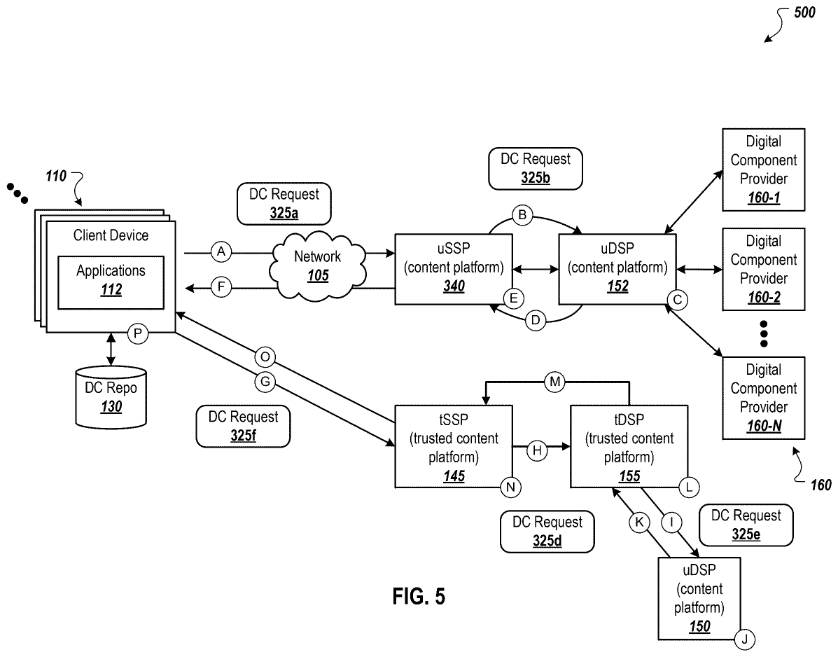

FIG. 5 is a block diagram of the example environment 500 in which digital components 115 are selected for client devices 110 in a privacy preserving manner. An example process for selecting and providing a digital component 115 for display at a client device 110 is illustrated in stages A-P. In this example, stages B-D can be the same as or similar to stages B-D of FIG. 3. Similarly, stages H-M can be similar to stages F to K of FIG. 3.

FIG. 5 differs from FIG. 3 in that the uSSP 340 does not provide the digital component request 325c to the tSSP 145 as in stage E of FIG. 3, and the tSSP 145 does not send candidate digital components (e.g., encrypted trusted candidate digital components) to the uSSP 340 as in stage M of FIG. 3. Instead, the client device 110 sends two digital component requests to two different content platforms and receives candidate digital components from the two different content platforms.

In particular, the client device 110 can obtain a first set of candidate digital components from untrusted content platforms uSSP 340 and uDSP(s) 152 by sending a digital component request 325a to the uSSP 340. Since these are untrusted content platforms, this digital component request 325 can include non-sensitive data for selecting untrusted digital components but may not include non-sensitive data. The uSSP can obtain untrusted candidate digital components using stages B to D, which can be the same as, or similar to, stages A-D, respectively, of FIG. 3. In stage E, the uSSP 340 can filter the untrusted candidate digital components received from the uDSP(s) 152, e.g., using publisher controls, and send the remaining untrusted candidate digital components to the client device 110 in stage F for inclusion in a digital component selection process performed by the client device 110. The uSSP 340 can also send, for each untrusted candidate digital component, a selection value and/or other distribution parameters.

The client device 110 can also obtain a second set of candidate digital components from trusted content platforms uSSP 145 and tDSP 155 by sending a digital component request 325f to the tSSP 145. This digital component request 325f can include sensitive data and optionally non-sensitive data that can be used to select trusted and/or untrusted candidate digital components. In stage G, the application 112 sends the digital component request 325f over the network 105 the tSSP 145. The tSSP 145 can obtain a set of candidate digital components using stages H-M, which can be the same as or similar to stages F-K, respectively, of FIG. 3.

In stage N, the tSSP 145 can select a subset of the candidate digital components obtained from the tDSP(s) 155 and send the subset of candidate digital components to the client device 110 in stage O. In some implementations, the tSSP 145 can encrypt any selected trusted digital components using an encryption key of the client device to generate encrypted trusted digital components before sending the trusted digital components to the client device in stage O. The tSSP 145 can also send, for each candidate digital component, a selection value and/or other distribution parameters.

In stage P, the client device 110 can perform a selection process to select one or more digital components to present to the user. The client device 110 can select the digital component(s) from among the first set of digital components obtained from the uSSP 340 and the second set of candidate digital components obtained from the tSSP 145. For example, the client device 110 can select one or more digital components based on the selection values for the candidate digital components, as described below.

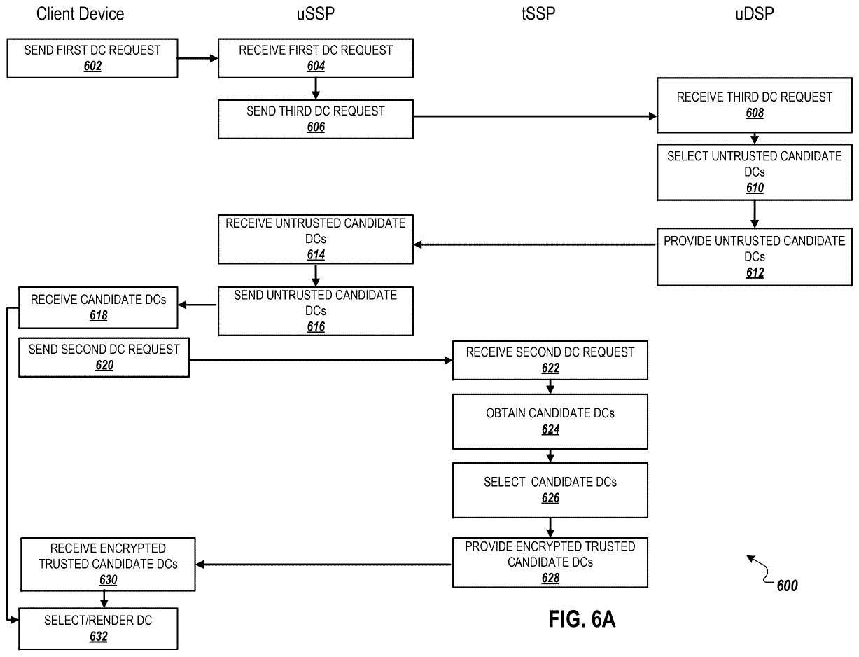

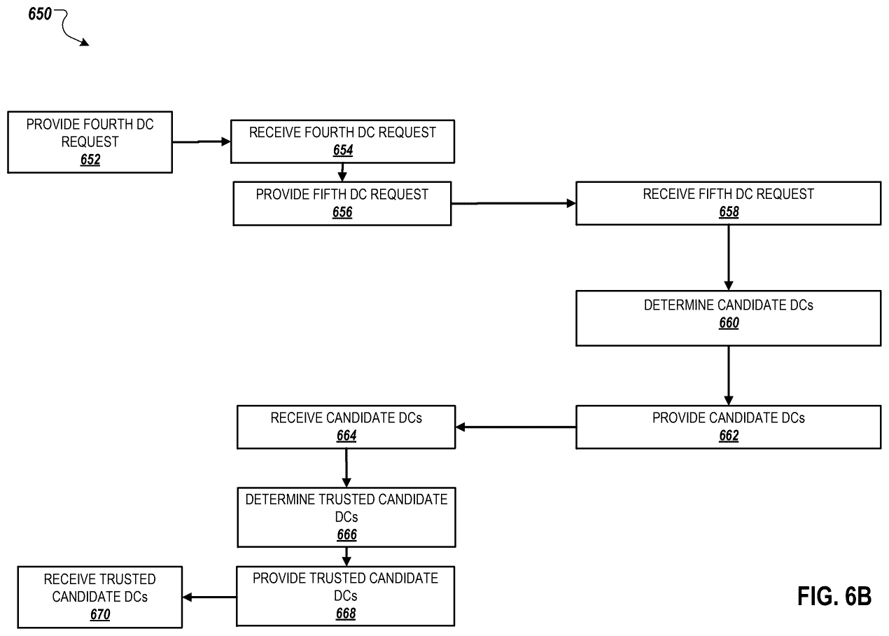

FIG. 6A is a flow diagram of an example process 600 for privacy-preserving content selection. For convenience, the process 600 will be described as being performed by the components of the environment 500 of FIG. 5, e.g., client devices 110 and content platforms 145, 150, 152, 155, 340 of FIG. 5 appropriately programmed to perform the process 600. Operations of the process 600 can also be implemented as instructions stored on one or more computer readable media, which may be non-transitory, and execution of the instructions by one or more data processing apparatus can cause the one or more data processing apparatus to perform the operations of the process 600. One or more other components described herein can perform operations of the process 600.

The client device can send (602) a first digital component request to one or more uSSPs. Each first digital component request can include first party-data for first party entities, e.g., one or more uDSPs, contextual data, and/or other non-sensitive data. Each uSSP can receive (604) a first digital component request.

Each uSSP can send (606) a third digital component request to one or more uDSPs. Each third digital component request can include first-party data for the uDSP and/or other non-sensitive data.

Each uDSP can receive (608) a third digital component request.

The uDSP can select (610) untrusted candidate digital components. For example, the uDSP selects the untrusted candidate digital components using the non-sensitive data of the third digital component request.

Each uDSP can provide (612) the untrusted candidate digital components, and the uSSP can receive (614) the untrusted candidate digital components. The uDSP can also send, for each untrusted digital component, distribution parameters that include a selection value for the untrusted digital component.

The uSSP can send (616) the untrusted candidate digital components to the client device. In some implementation, the uSSP can filter the untrusted digital components, e.g., using publisher controls, and send the remaining untrusted candidate digital components to the client device. The uSSP can also send, for each untrusted digital component, distribution parameters that include a selection value for the untrusted digital component.

The client device can receive (618) the untrusted candidate digital components.

The client device sends (620) and the tSSP receives (622) a second digital component request that requests one or more digital components for display at the client device. The second digital component request can include sensitive data, e.g., encrypted user data, and optionally non-sensitive data.

The tSSP can obtain (624) trusted candidate digital components and/or untrusted digital components. For example, the tSSP can obtain trusted candidate digital components and/or untrusted digital components from one or more tDSPs, as described in further detail with reference to FIG. 6B.

FIG. 6B is a flow diagram of an example process 650 for obtaining candidate digital components. For convenience, the process 650 will be described as being performed by components for obtaining digital components, such as the tSSP (e.g., tSSP 145), tDSP (e.g., tDSP 155), and a uDSP (e.g., uDSP 152 of FIG. 5). Operations of the process 650 can also be implemented as instructions stored on one or more computer readable media, which may be non-transitory, and execution of the instructions by one or more data processing apparatus can cause the one or more data processing apparatus to perform the operations of the process 650. One or more other components described herein can perform operations of the process 650.

The tSSP can provide (652) a fourth digital component request to one or more tDSPs. The fourth digital component request can include sensitive data and optionally non-sensitive data of the second digital component request.

The tDSP can receive (654) the fourth digital component request.

The tDSP can provide (656) a fifth digital component request to a corresponding uDSP that is operated by or on behalf of the same entity as the tDSP. The fifth digital component request can include the non-sensitive data of the fourth digital component request.

The uDSP (658) can receive the fifth digital component request. The uDSP can select (660) candidate digital components. For example, the uDSP can select trusted candidate digital components and/or untrusted candidate digital components based on the non-sensitive data, as described above with reference to stage J of FIG. 5. The uDSP can also generate or otherwise obtain an initial selection value for each candidate digital component.

The uDSP can provide (662) and the tDSP can receive (664) the candidate digital components and their initial selection values. The uDSP can also provide other distribution parameters that can be used by the tDSP to select candidate digital components and/or generate selection values for the candidate digital components.

The tDSP can select (666), from the candidate digital components received from the uDSP, candidate digital components to provide to the tSSP in response to the fourth digital component request. The selected digital components can include trusted candidate digital components and/or untrusted digital components. Here, the tDSP can decrypt the user data and use the user data to select the candidate digital components and/or determine a selection value for each candidate digital component. For example, the tDSP can filter, from the candidate digital components, any trusted digital components for which the sensitive constraint criteria are not satisfied. The tDSP can also update initial selection values for the candidate digital components based on the user data and/or the non-sensitive data.

The tDSP can provide (668) and the tSSP can receive (670) the selected candidate digital components.

Returning to FIG. 6A, the tSSP can select (626), from a set of candidate digital components received from one or more tDSPs, candidate digital components to provide to the client device in response to the second digital component request. The tSSP can use the selection values to select candidate digital components. For example, the tSSP can select a specified number of candidate digital components with the highest selection values or candidate digital components having a selection value that satisfies a threshold (e.g., by meeting or exceeding the threshold). In some implementations, the tSSP can select the candidate digital components having the highest scores, where the score for each candidate digital component is based on the selection value and a predicted performance (e.g., predicted interaction rate) of the candidate digital component.

The tSSP can provide (628) the selected candidate digital components to the client device. In some implementations, the tSSP can encrypt each selected trusted candidate digital component, if any, before sending the selected trusted candidate digital component to the client device. The client device can receive (630) the candidate digital components from the tSSP.

In some implementations, operations 602-618 and operations 620-630 can be performed in parallel, reducing the latency compared to performing the groups of operations sequentially.

The client device can select (632) one or more digital components to present to the user. The client device can select the one or more digital components from a set of candidate digital components that includes the untrusted candidate digital components received from the uSSP and the candidate digital components (e.g., trusted and/or untrusted candidate digital components) received from the tSSP. The set of candidate digital components can also include candidate digital components stored in a digital component repository of the client device.

The client device can select a digital component for each digital component slot of a resource for which the digital component(s) are being requested by the client device. The client device can perform a selection process to select the digital components. For example, the client device can select, for a digital component slot, the candidate digital component having the highest selection value or the highest score that is based on the selection value and a predicted performance for the candidate digital component.

In some implementations, the client device can adjust the selection values for the candidate digital components before making a selection. For example, the client device can store additional sensitive data not provided to the trusted content platforms and use this data to adjust the selection values for the candidate digital components.

The client device can then present the selected digital component(s). In some implementations, the client device can present any trusted digital components that are selected in a fenced frame of the application with which the trusted digital component is presented. The fenced frame can decrypt the trusted digital component such that the client device or application cannot identify the trusted digital component and therefore cannot learn about the user based on the trusted digital component.

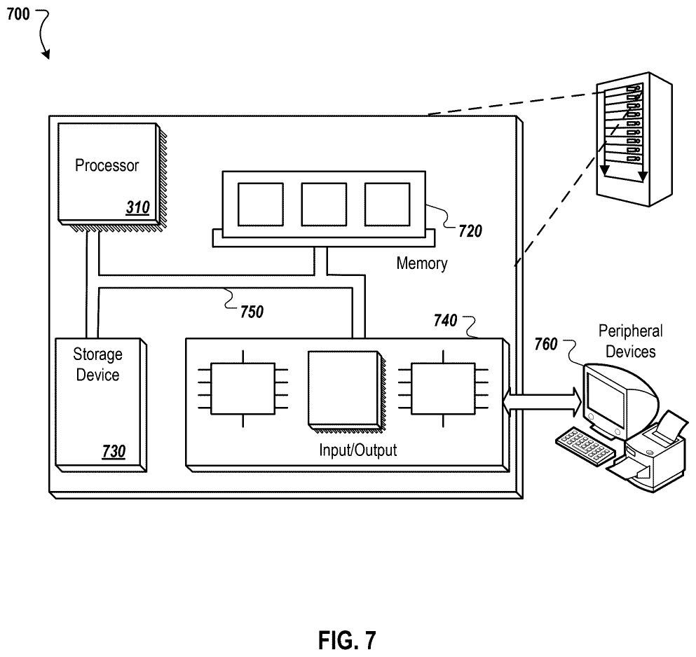

FIG. 7 is a block diagram of an example computer system 700 that can be used to perform operations described above. The system 700 includes a processor 710, a memory 720, a storage device 730, and an input/output device 740. Each of the components 710, 720, 730, and 740 can be interconnected, for example, using a system bus 750. The processor 710 is capable of processing instructions for execution within the system 700. In one implementation, the processor 710 is a single-threaded processor. In another implementation, the processor 710 is a multi-threaded processor. The processor 710 is capable of processing instructions stored in the memory 720 or on the storage device 730.

The memory 720 stores information within the system 700. In one implementation, the memory 720 is a computer-readable medium. In one implementation, the memory 720 is a volatile memory unit. In another implementation, the memory 720 is a non-volatile memory unit.

The storage device 730 is capable of providing mass storage for the system 700. In one implementation, the storage device 730 is a computer-readable medium. In various different implementations, the storage device 730 can include, for example, a hard disk device, an optical disk device, a storage device that is shared over a network by multiple computing devices (e.g., a cloud storage device), or some other large capacity storage device.

The input/output device 740 provides input/output operations for the system 700. In one implementation, the input/output device 740 can include one or more of a network interface devices, e.g., an Ethernet card, a serial communication device, e.g., and RS-232 port, and/or a wireless interface device, e.g., and 802.11 card. In another implementation, the input/output device can include driver devices configured to receive input data and send output data to other devices, e.g., keyboard, printer, display, and other peripheral devices 760. Other implementations, however, can also be used, such as mobile computing devices, mobile communication devices, set-top box television client devices, etc.

Although an example processing system has been described in FIG. 7, implementations of the subject matter and the functional operations described in this specification can be implemented in other types of digital electronic circuitry, or in computer software, firmware, or hardware, including the structures disclosed in this specification and their structural equivalents, or in combinations of one or more of them.

An electronic document (which for brevity will simply be referred to as a document) does not necessarily correspond to a file. A document may be stored in a portion of a file that holds other documents, in a single file dedicated to the document in question, or in multiple coordinated files.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented using one or more modules of computer program instructions encoded on a computer-readable medium for execution by, or to control the operation of, data processing apparatus. The computer-readable medium can be a manufactured product, such as a hard drive in a computer system or an optical disc sold through retail channels, or an embedded system. The computer-readable medium can be acquired separately and later encoded with the one or more modules of computer program instructions, such as by delivery of the one or more modules of computer program instructions over a wired or wireless network. The computer-readable medium can be a machine-readable storage device, a machine-readable storage substrate, a memory device, or a combination of one or more of them.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, a runtime environment, or a combination of one or more of them. In addition, the apparatus can employ various different computing model infrastructures, such as web services, distributed computing and grid computing infrastructures.

A computer program (also known as a program, software, software application, script, or code) can be written in any suitable form of programming language, including compiled or interpreted languages, declarative or procedural languages, and it can be deployed in any suitable form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, special purpose microprocessors. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM (Erasable Programmable Read-Only Memory), EEPROM (Electrically Erasable Programmable Read-Only Memory), and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

To provide for interaction with a user, embodiments of the subject matter described in this specification can be implemented on a computing device capable of providing information to a user. The information can be provided to a user in any form of sensory format, including visual, auditory, tactile or a combination thereof. The computing device can be coupled to a display device, e.g., an LCD (liquid crystal display) display device, an OLED (organic light emitting diode) display device, another monitor, a head mounted display device, and the like, for displaying information to the user. The computing device can be coupled to an input device. The input device can include a touch screen, keyboard and a pointing device, e.g., a mouse or a trackball, by which the user can provide input to the computing device. Other kinds of devices can be used to provide for interaction with a user as well; for example, feedback provided to the user can be any suitable form of sensory feedback, e.g., visual feedback, auditory feedback, or tactile feedback; and input from the user can be received in any suitable form, including acoustic, speech, or tactile input.

The computing system can include clients and servers. A client and server are generally remote from each other and typically interact through a communication network. The relationship of client and server arises by virtue of computer programs running on the respective computers and having a client-server relationship to each other. Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described is this specification, or any combination of one or more such back-end, middleware, or front-end components. The components of the system can be interconnected by any suitable form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While this specification contains many implementation details, these should not be construed as limitations on the scope of what is being or may be claimed, but rather as descriptions of features specific to particular embodiments of the disclosed subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination. Thus, unless explicitly stated otherwise, or unless the knowledge of one of ordinary skill in the art clearly indicates otherwise, any of the features of the embodiments described above can be combined with any of the other features of the embodiments described above.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and/or parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the invention have been described. Other embodiments are within the scope of the following claims. For example, the actions recited in the claims can be performed in a different order and still achieve desirable results.

1. A computer-implemented method comprising:
receiving, by a first trusted content platform and from a client device of a user, a first digital component request comprising (i) sensitive data comprising encrypted user data for the user and (ii) non-sensitive data comprising contextual data related to a resource with which a selected digital component will be presented at the client device;
sending, by the first trusted content platform, a second digital component request comprising the encrypted user data to one or more second trusted content platforms;
receiving, by the first trusted content platform and from each second trusted content platform, one or more first candidate digital components;
sending, by the first trusted content platform, a third digital component request to each of one or more second untrusted content platforms, wherein the third digital component request sent to each second untrusted content platform comprises the contextual data;
receiving, by the first trusted content platform and from each second untrusted content platform, one or more second candidate digital components;
selecting, by the first trusted content platform, a given digital component from a set of candidate digital components comprising the one or more first candidate digital components received from each second trusted content platform and the one or more second candidate digital components received from each second untrusted content platform; and
sending the given digital component to the client device of the user for presentation with the resource.

2. The computer-implemented method of claim 1, wherein the second digital component request comprises first-party data related user actions of a user of the client device with respect to one or more resources of a publisher of the resource.

3. The computer-implemented method of claim 1, wherein at least part of the first trusted content platform or at least a part of the one or more second trusted content platforms is implemented on the client device.

4. The computer-implemented method of claim 1, wherein the one or more first candidate digital components are selected from one or more second trusted repositories of digital components, wherein each of the one or more second trusted repositories is maintained by a corresponding second trusted content platform.

5. The computer-implemented method of claim 1, wherein the one or more second candidate digital components are selected from one or more second untrusted repositories of digital components, wherein each of the one or more second untrusted repositories is maintained by a corresponding second untrusted content platform.

6. The computer-implemented method of claim 1, wherein each second trusted content platform is configured to send the non-sensitive data to a corresponding second untrusted content platform operated by a same entity that operates the second trusted content platform.

7. The computer-implemented method of claim 6, wherein the corresponding second untrusted content platform is configured to select one or more candidate digital components based on the non-sensitive data, and wherein the corresponding second untrusted content platform is configured to send the selected one or more candidate digital components to the second trusted content platform.

8. The computer-implemented method of claim 7, wherein each second trusted content platform is configured to decrypt the encrypted user data and to generate a selection value for each of a set of candidate digital components comprising the first candidate digital components and the selected one or more candidate digital components based on the decrypted user data, and wherein the second trusted content platform selects the given digital component from the set of candidate digital components based on the generated selection value for each candidate digital component.

9. The computer-implemented method of claim 7, wherein each second trusted content platform is configured to:
decrypt the encrypted user data;
generate, based at least on the decrypted user data, a score for each candidate digital component in the set of candidate digital components based on a selection value for the candidate digital component and a predicted performance metric for the candidate digital component; and
select the given candidate digital component based on the score for each candidate digital component.

10. The computer-implemented method of claim 1, wherein selecting, by the first trusted content platform, a given digital component from a set of candidate digital components comprises:
receiving, from each second trusted content platform and each of the one or more second untrusted content platform, a selection value for each candidate digital component; and
selecting the given digital component based on the selection values.

11. A computer-implemented method, comprising:
receiving, by a first untrusted content platform and from a client device of a user, a first digital component request comprising (i) sensitive data comprising encrypted user data for the user and (ii) non-sensitive data comprising contextual data related to a resource with which a selected digital component will be presented at the client device;
sending, by the first untrusted content platform, a second digital component request comprising the sensitive data to one or more first trusted content platforms;
receiving, by the first untrusted content platform and from each second trusted content platform, one or more encrypted trusted candidate digital components;
sending, by the first untrusted content platform, a third digital component request to one or more second untrusted content platforms, wherein the third digital component request sent to each second untrusted content platform comprises the non-sensitive data;
receiving, by the first untrusted content platform and from each second untrusted content platform, one or more untrusted candidate digital components; and
sending one or more of the encrypted trusted candidate digital components and the candidate digital components to the client device of the user for presentation with the resource.

12. The computer-implemented method of claim 11, wherein the first trusted content platform is configured to send the encrypted user data to one or more second trusted content platforms, and receive one or more trusted candidate digital components from each of the second trusted content platforms.

13. The computer-implemented method of claim 11, wherein at least one of the one or more second trusted content platforms is configured to send first-party data to a corresponding second untrusted content platform.

14. The computer-implemented method of claim 13, wherein the corresponding second untrusted content platform is configured to select candidate digital components based on the first-party data, and wherein the corresponding second untrusted content platform is configured to send the selected candidate digital components to the second trusted content platform.

15. The computer-implemented method of claim 14, wherein the second trusted content platform is configured to select one or more of the selected candidate digital components to send to the first trusted content platform as trusted candidate digital components based on the encrypted user data.

16. The computer-implemented method of claim 11, wherein the first trusted content platform is configured to select one or more of the trusted candidate digital components received from the second trusted content platforms to send as encrypted trusted candidate digital components to the first untrusted content platform.

17. A computer-implemented method, comprising:
sending, by a client device of a user, a first digital component request to one or more first untrusted content platforms, the first digital component request comprising non-sensitive data comprising contextual data related to a resource with which a selected digital component will be presented at the client device;
receiving, by the client device, one or more untrusted candidate digital components from the one or more first untrusted content platforms;
sending, by the client device, a second digital component request to one or more first trusted content platforms, the second digital component request comprising user data;
receiving, by the client device, one or more trusted candidate digital components from the one or more first trusted content platforms; and
selecting, by the client device, a given digital component from a set of candidate digital components comprising the one or more untrusted candidate digital components received from each first untrusted content platform and the one or more encrypted trusted candidate digital components received from each first trusted content platform for presentation with the resource.

18. The computer-implemented method of claim 17, wherein each trusted candidate digital component is encrypted, the method further comprising presenting a trusted candidate digital component in a fenced frame.

19. The computer-implemented method of claim 17 or 18, wherein each first untrusted content platform is configured to:
send a third digital component request to one or more second untrusted content platforms, the third digital component request comprising the non-sensitive data and first-party data related user actions of a user of the client device with respect to one or more resources of a publisher of the resource; and
receive one or more untrusted candidate digital components from the one or more second untrusted content platforms.

20. The computer-implemented method of claim 17, wherein the first trusted content platform is configured to send a fourth digital component request comprising encrypted user data to one or more second trusted content platforms, and receive one or more trusted candidate digital components from each of the second trusted content platforms.

21. The computer-implemented method of claim 20, wherein at least one of the one or more second trusted content platforms is configured to send a fifth digital component request comprising the non-sensitive data and first-party data related user actions of a user of the client device with respect to one or more resources of a publisher of the resource.

22. The computer-implemented method of claim 21, wherein the corresponding second untrusted content platform is configured to select candidate digital components based on the non-sensitive data and the first-party data, and wherein the corresponding second untrusted content platform is configured to send the selected candidate digital components to the second trusted content platform.

23. The computer-implemented method of claim 22, wherein the second trusted content platform is configured to select one or more of the selected candidate digital components to send to the first trusted content platform as trusted candidate digital components based on the encrypted user data.

24. The computer-implemented method of claim 22, wherein the first trusted content platform is configured to select one or more of the trusted candidate digital components received from the second trusted content platforms to send as encrypted trusted candidate digital components to the client device.

25. The computer-implemented method of claim 17, wherein the first trusted content platform is configured to send, to each of the second trusted content platforms, the encrypted user data and the non-sensitive data for the second trusted content platform.

26. The computer-implemented method of claim 17, wherein selecting, by the client device, a given digital component from a set of candidate digital components comprises:
receiving, from each first untrusted content platform and each first trusted content platform, a selection value for each of the candidate digital components in the set of candidate digital components; and
selecting the given digital component based on the selection values.

27. The computer-implemented method of claim 17, wherein selecting, by the client device, a given digital component from a set of candidate digital components comprises:
determining, for each candidate digital component in the set of candidate digital components, a score based on a selection value for the candidate digital component and a predicted performance metric for the candidate digital component; and
selecting the given digital component based on the score for each candidate digital component.

28. (canceled)

29. (canceled)

30. (canceled)
